(19) United States
(12) Patent Application Publication
(10) Pub. No.: US 2024/0144833 A1
(43) Pub. Date: May 2, 2024

(54) CUSTOMIZED PREOPERATIONAL GRAPHICAL USER INTERFACE AND REMOTE VEHICLE MONITORING FOR AIRCRAFT SYSTEMS CHECK

(71) Applicant: Skyryse, Inc., El Segundo, CA (US)

(72) Inventors: Daniel James Stillion, San Carlos, CA (US); Christopher Camilo Cole, Santa Monica, CA (US); Gonzalo Javier Rey, Torrence, CA (US); Mark Daniel Groden, Marina del Rey, CA (US)

(21) Appl. No.: 18/499,641

(22) Filed: Nov. 1, 2023

Related U.S. Application Data
(60) Provisional application No. 63/421,631, filed on Nov. 2, 2022.

(51) Int. Cl. G08G 5/00

(52) U.S. Cl. CPC G08G 5/0026; G08G 5/0013

(57) ABSTRACT

Embodiments relate to generating and using a customized preflight checklist graphical user interface (GUI) specific to a specified aircraft. A client device may receive a selection of an aircraft to be piloted by a user and retrieves sensor data generated by a sensor of the aircraft. The client device may update a preflight checklist GUI based in part on the sensor data and the aircraft such that the preflight checklist GUI is a customized preflight checklist GUI specific to the aircraft. After determining that a set of preflight checks of the customized preflight checklist GUI are completed, the client device may transmit an authorization to the specified aircraft that authorizes the specified aircraft.

### CROSS-REFERENCE TO RELATED APPLICATION(S)

This application claims a benefit of, and priority to, U.S. Provisional Patent Application Ser. No. 63/421,631, “Customized Preoperational Checklist Graphical User Interface and Remote Vehicle Monitoring,” filed on Nov. 2, 2022, which is incorporated herein by reference in its entirety.

### TECHNICAL FIELD

The disclosure generally relates to a preoperational aircraft flight operational checks, and more particularly to a customized preoperational graphical user interface for checks specific to a selected vehicle as well as interface for remotely monitoring a vehicle.

### BACKGROUND

A pilot will often conduct a preflight review process of an aircraft before piloting the aircraft. The purpose of the preflight review is to confirm the aircraft is capable of properly and safely operating. While performing the preflight review, it may be helpful for the pilot to reference a preflight checklist that lists tasks to be completed as a part of a systems testing process relative to a specific aircraft to be flown.

A problem with conventional checklists is that they are typically paper based and may further be generic. The pilot typically is required to conduct a visual or auditory test of a system component, confirm that the test has passed, and continue with the process. This process, however, is tedious, time consuming, and requires familiarity of the aircraft and components to be tested. A lack of familiarity with the aircraft, for example, may cause a check to be improperly administered. Further by example, a system check may be inadvertently missed due to an unforeseen distraction. In another example, a system check may appear reasonable for a particular system check but may be incompatible with another corresponding system check that itself may appear reasonable.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates an example vehicle control and interface system, in accordance with one or more embodiments.

FIG. 2 illustrates an example configuration for a set of universal vehicle control interfaces in a vehicle, in accordance with one or more embodiments.

FIG. 3 is a block diagram of an aerial network for generating and providing customized preflight checklist graphical user interfaces (GUIs), in accordance with one or more embodiments.

FIG. 4A is a screenshot of a GUI welcome screen, in accordance with one or more embodiments.

FIG. 4B is a first screenshot of a customized preflight checklist GUI, in accordance with one or more embodiments.

FIG. 4C is a second screenshot of the customized preflight checklist GUI, in accordance with one or more embodiments.

FIG. 4D is a third screenshot of the customized preflight checklist GUI, in accordance with one or more embodiments.

FIG. 4E is a fourth screenshot of the customized preflight checklist GUI, in accordance with one or more embodiments.

FIG. 4F is a fifth screenshot of the customized preflight checklist GUI, in accordance with one or more embodiments.

FIG. 4G is a sixth screenshot of the customized preflight checklist GUI, in accordance with one or more embodiments.

FIG. 4H is a seventh screenshot of the customized preflight checklist GUI, in accordance with one or more embodiments.

FIG. 4I is an eighth screenshot of the customized preflight checklist GUI, in accordance with one or more embodiments.

FIG. 4J is a ninth screenshot of the customized preflight checklist GUI, in accordance with one or more embodiments.

FIG. 4K is a tenth screenshot of the customized preflight checklist GUI, in accordance with one or more embodiments.

FIG. 4L is an eleventh screenshot of the customized preflight checklist, in accordance with one or more embodiments.

FIG. 4M is a twelfth screenshot of the customized preflight checklist GUI, in accordance with one or more embodiments.

FIG. 5A is a screenshot of another customized checklist GUI, in accordance with one or more embodiments.

FIG. 5B is a screenshot of another a customized checklist GUI, in accordance with one or more embodiments.

FIG. 6 is a flowchart for remotely monitoring an aircraft, in accordance with one or more embodiments.

FIG. 7A is a flowchart for steps that may occur when a user approaches an aircraft, in accordance with one or more embodiments.

FIG. 7B is a flowchart for steps that may occur during a preflight check, in accordance with one or more embodiments.

FIG. 8 is a flowchart for steps that may occur while a user is performing manual preflight checks, in accordance with one or more embodiments.

FIG. 9 is a flowchart describing an example method of generating and using a customized preflight checklist GUI specific to a selected aircraft, in accordance with one or more embodiments.

FIG. 10 is a block diagram illustrating one example embodiment of components of an example machine able to read instructions from a machine-readable medium and execute them in a processor (or controller).

### DETAILED DESCRIPTION

The figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A person generally conducts a preflight check of an aircraft before piloting the aircraft (e.g., prior to takeoff, prior to turning on the aircraft, or prior to turning on an aircraft engine). The purpose of the preflight check is to confirm the aircraft is capable of properly and safely operating (e.g., flying to a predetermined destination). While performing the preflight check, it may be helpful for the person to reference a preflight checklist. The preflight checklist includes a list of tasks to be completed or performed before piloting an aircraft. The checklist helps ensure that no (e.g., important) tasks are forgotten. In fact, failure to correctly conduct a preflight check using a preflight checklist is a major contributing factor to aircraft accidents. In some cases, a preflight checklist is required to be completed before piloting an aircraft. However, some preflight checklists are static documents that do not provide information specific to a selected aircraft. Furthermore, a user may need to manually complete certain tasks on the checklist (e.g., getting in the aircraft and checking a fuel gauge to determine the fuel level of the aircraft), which can be tedious and time consuming.

Some embodiments described herein overcome the limitations described above. For example, a client device may present a preflight checklist graphical user interface (GUI) customized for an aircraft selected by a user. The customized preflight checklist GUI may include sensor data from the aircraft to help the user complete the preflight checklist faster and with more accuracy. Furthermore, the client device may validate completion of certain tasks on the preflight checklist and may authorize the user to pilot the aircraft after the preflight checklist is complete. By validating certain tasks and waiting to authorize the user, the client device may help ensure one or more necessary or important preflight checks are completed before the user begins piloting the aircraft.

In some embodiments, the preflight checklist (GUI) may be displayed in display of an aircraft or via a separate client device, e.g., a smartphone or a tablet computing device. The GUI may be associate with an application (or app), in a web-based application (e.g., supervisory UI that is web based that a fleet manager might be able to access), or some combination thereof. In the case of a separate client device, the client device may be configured to be communicatively coupled with system components of the aircraft, e.g., sensors, mechanical systems, electrical systems, etc.

Although the above description refers to performing preflight checks for aircraft, embodiments described herein may be more broadly applicable to performing pre-operational checks for vehicles. For example, a customized pre-operational checklist GUI for a ground vehicle is generated and displayed based on the selected ground vehicle and sensor data generated from a sensor of the ground vehicle.

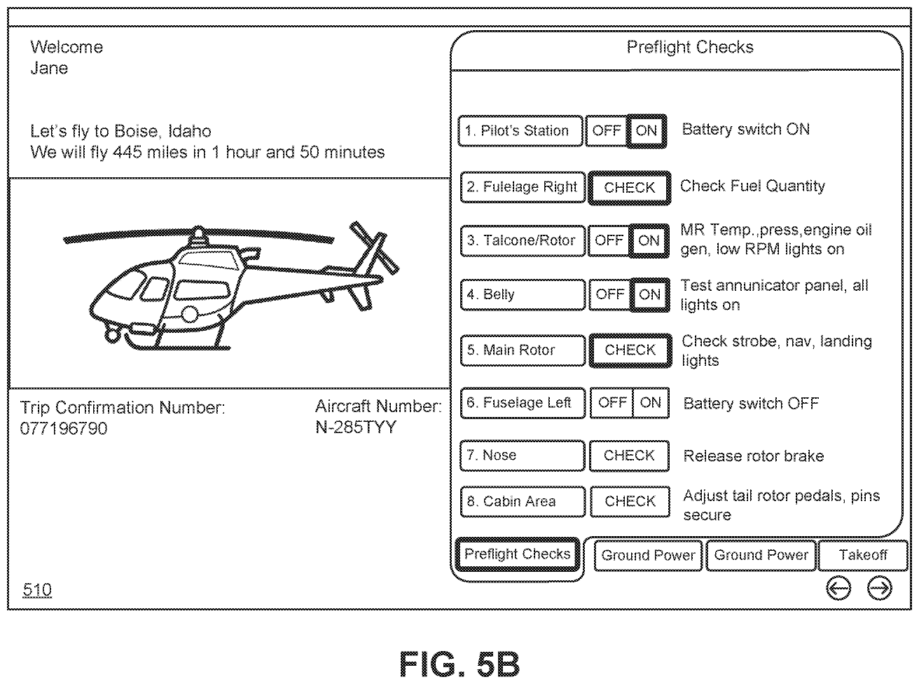

In some embodiments, a user can remotely monitor a vehicle. Remote monitoring allows a user to connect to a vehicle (via a client computing device) to check the state of the vehicle (e.g., check fuel quantity, global positioning system (GPS) position, and other quantities). Remote monitoring may be useful if the user is distant from the vehicle but would like to check the state of the vehicle. A specific example of remotely monitoring an aircraft is described below with respect to FIG. 6.

Furthermore, while embodiments can help a user complete pre-operational checks (e.g., preflight checks) for vehicles, the user is responsible for confirming the vehicle (e.g., aircraft) can be properly and safely operated before the user operates the vehicle.

Other aspects include components, devices, systems, improvements, methods, processes, applications, computer readable mediums, and other technologies related to any of the above.

### Example Vehicle Control and Interface

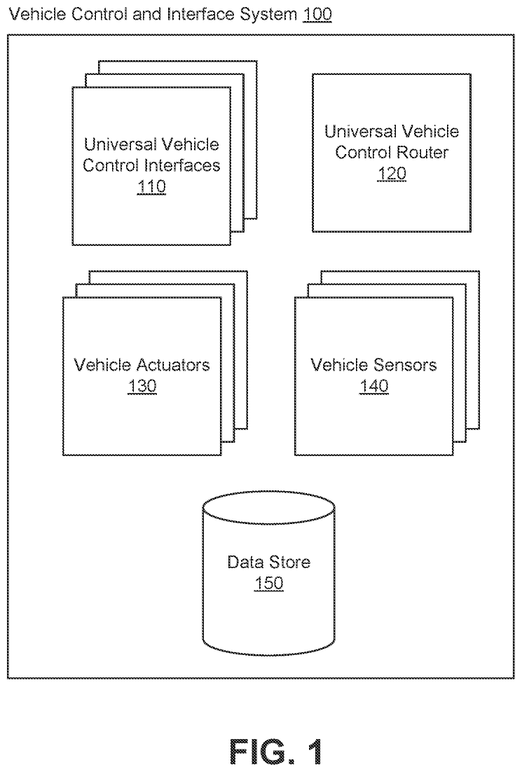

Before further describing preflight checklists, example vehicle controls and interfaces are described with respect to FIGS. 1-2. FIG. 1 illustrates an example vehicle control and interface system 100, in accordance with one or more embodiments. In the example embodiment shown, vehicle control and interface system 100 includes one or more universal vehicle control interfaces 110, universal vehicle control router 120, one or more vehicle actuators 130, one or more vehicle sensors 140, and one or more data stores 150. In other embodiments, the vehicle control and interface system 100 may include different or additional elements. Furthermore, the functionality may be distributed among the elements in a different manner than described. The elements of FIG. 1 may include one or more computers that communicate via a network or other suitable communication method.

The vehicle control and interface system 100 may be integrated with various vehicles having different mechanical, hardware, or software components. For example, the vehicle control and interface system 100 may be integrated with fixed-wing aircraft (e.g., airplanes) or rotorcraft (e.g., helicopters). The principles described may be extended to motor vehicles (e.g., automobiles), watercraft (e.g., power boats or submarines), or any other suitable vehicle that may require a pre-operational systems check prior to operation. The vehicle control and interface system 100 is advantageously configured to receive inputs for requested operation of a particular vehicle via universal set of interfaces and the inputs to appropriate instructions for mechanical, hardware, or software components of the particular vehicle to achieve the requested operation. In doing so, the vehicle control and interface system 100 enables human operators to operate different vehicles using the same universal set of interfaces or inputs. By way of example, “universal” indicates that a feature of the vehicle control and interface system 100 may operate or be architected in a vehicle-agnostic manner. This allows for vehicle integration without necessarily having to design and configure vehicle specific customizations or reconfigurations in order to integrate the specific feature. Although universal features of the vehicle control and interface system 100 can function in a vehicle-agnostic manner, the universal features may still be configured for particular contexts. For example, the vehicle control or interface system 100 may receive or process inputs describing three-dimensional movements for vehicles that can move in three dimensions (e.g., aircraft) and conversely may receive or process inputs describing two-dimensional movements for vehicles that can move in two dimensions (e.g., automobiles). One skilled in the art will appreciate that other context-dependent configurations of universal features of the vehicle control and interface system 100 are possible.

The universal vehicle control interfaces 110 is a set of universal interfaces configured to receive a set of universal vehicle control inputs to the vehicle control and interface system 100. The universal vehicle control interfaces 110 may include one or more digital user interfaces presented to an operator of a vehicle via one or more electronic displays. Additionally, or alternatively, the universal vehicle control interfaces 110 may include one or more hardware input devices, e.g., one or more control sticks inceptors, such as side sticks, center sticks, throttles, cyclic controllers, or collective controllers. The universal vehicle control interfaces 110 receive universal vehicle control inputs requesting operation of a vehicle. In particular, the inputs received by the universal vehicle control interfaces 110 may describe a requested trajectory of the vehicle, such as to change a velocity of the vehicle in one or more dimensions or to change an orientation of the vehicle. Because the universal vehicle control inputs describe an intended trajectory of a vehicle directly rather than describing vehicle-specific precursor values for achieving the intended trajectory, such as vehicle attitude inputs (e.g., power, lift, pitch, roll yaw), the universal vehicle control inputs can be used to universally describe a trajectory of any vehicle. This is in contrast to existing systems where control inputs are received as vehicle-specific trajectory precursor values that are specific to the particular vehicle. Advantageously, any individual interface of the set of universal vehicle control interfaces 110 configured to received universal vehicle control inputs can be used to completely control a trajectory of a vehicle. This is in contrast to conventional systems, where vehicle trajectory must be controlled using two or more interfaces or inceptors that correspond to different axes of movement or vehicle actuators. For instance, conventional rotorcraft systems include different cyclic (controlling pitch and roll), collective (controlling heave), and pedal (controlling yaw) inceptors. Similarly, conventional fixed-wing aircraft systems include different stick or yoke (controlling pitch and role), power (controlling forward movement), and pedal (controlling yaw) inceptors. Example configurations of the universal vehicle control interfaces 110 are described in greater detail below with reference to FIG. 2.

In various embodiments, inputs received by the universal vehicle control interfaces 110 can include “steady-hold” inputs, which may be configured to hold a parameter value fixed (e.g., remain in a departed position) without a continuous operator input. Such variants can enable hands-free operation, where discontinuous or discrete inputs can result in a fixed or continuous input. In a specific example, a user of the universal vehicle control interfaces 110 can provide an input (e.g., a speed input) and subsequently remove their hands with the input remaining fixed. Alternatively, or additionally, inputs received by the universal vehicle control interfaces 110 can include one or more self-centering or automatic return inputs, which return to a default state without a continuous user input.

In some embodiments, the universal vehicle control interfaces 110 include interfaces that provide feedback information to an operator of the vehicle. For instance, the universal vehicle control interfaces 110 may provide information describing a state of a vehicle integrated with the universal vehicle control interfaces 110 (e.g., current vehicle speed, direction, orientation, location, etc.). Additionally, or alternatively, the universal vehicle control interfaces 110 may provide information to facilitate navigation or other operations of a vehicle, such as visualizations of maps, terrain, or other environmental features around the vehicle.

The universal vehicle control router 120 routes universal vehicle control inputs describing operation of a vehicle to components of the vehicle suitable for executing the operation. In particular, the universal vehicle control router 120 receives universal vehicle control inputs describing the operation of the vehicle, processes the inputs using information describing characteristics of the aircraft, and outputs a corresponding set of commands for actuators of the vehicle (e.g., the vehicle actuators 130) suitable to achieve the operation. The universal vehicle control router 120 may use various information describing characteristics of a vehicle in order to convert universal vehicle control inputs to a suitable set of commands for actuators of the vehicle. Additionally, or alternatively, the universal vehicle control router 120 may convert universal vehicle control inputs to a set of actuator commands using a set of control laws that enforce constraints (e.g., limits) on operations requested by the universal control inputs. For example, the set of operational control laws may include velocity limits (e.g., to prevent stalling in fixed-wing aircraft), acceleration limits, turning rate limits, engine power limits, rotor revolution per minute (RPM) limits, load power limits, allowable descent altitude limits, etc. After determining a set of actuator commands, the universal vehicle control router 120 may transmit the commands to relevant components of the vehicle for causing corresponding actuators to execute the commands.

The universal vehicle control router 120 can decouple axes of movement for a vehicle in order to process received universal vehicle control inputs. In particular, the universal vehicle control router 120 can process a received universal vehicle control input for one axis of movement without impacting other axes of movement such that the other axes of movement remain constant. In this way, the universal vehicle control router 120 can facilitate “steady-hold” vehicle control inputs, as described above with reference to the universal vehicle control interfaces 110. This is in contrast to conventional systems, where a vehicle operator must manually coordinate all axes of movement independently for a vehicle in order to produce movement in one axis (e.g., a pure turn, a pure altitude climb, a pure forward acceleration, etc.) without affecting the other axes of movement.

In some embodiments, the universal vehicle control router 120 is configured to use one or more models corresponding to a particular vehicle to convert universal vehicle control inputs to a suitable set of commands for actuators of the vehicle. For example, a model may include a set of parameters (e.g., numerical values) that can be used as input to universal input conversion processes in order to generate actuator commands suitable for a particular vehicle. In this way, the universal vehicle control router 120 can be integrated with vehicles by substituting models used by processes of the universal vehicle control router 120, enabling efficient integration of the vehicle control and interface system 100 with different vehicles. The one or more models may be obtained by the universal vehicle control router 120 from a vehicle model database or other first-party or third-party system, e.g., via a network. In some cases, the one or more models may be static after integration with the vehicle control and interface system 100, such as if a vehicle integrated with the vehicle control and interface system 100 receives is certified for operation by a certifying authority (e.g., the United States Federal Aviation Administration). In some embodiments, parameters of the one or more models are determined by measuring data during real or simulated operation of a corresponding vehicle and fitting the measured data to the one or more models.

In some embodiments, the universal vehicle control router 120 processes universal vehicle control inputs according to a current phase of operation of the vehicle. For instance, if the vehicle is a rotorcraft, the universal vehicle control router 120 may convert a universal input describing an increase in lateral speed to one or more actuator commands differently if the rotorcraft is in a hover phase or in a forward flight phase. In particular, in processing the lateral speed increase universal input the universal vehicle control router 120 may generate actuator commands causing the rotorcraft to strafe if the rotorcraft is hovering and causing the rotorcraft to turn if the rotorcraft is in forward flight. As another example, in processing a turn speed increase universal input the universal vehicle control router 120 may generate actuator commands causing the rotorcraft to perform a pedal turn if the rotorcraft is hovering and ignore the turn speed increase universal input if the rotorcraft is in another phase of operation. As a similar example for a fixed-wing aircraft, in processing a turn speed increase universal input the universal vehicle control router 120 may generate actuator commands causing the fixed-wing aircraft to perform tight ground turn if the fixed-wing aircraft is grounded and ignore the turn speed increase universal input if the fixed-wing aircraft is in another phase of operation. One skilled in the art will appreciate that the universal vehicle control router 120 may perform other suitable processing of universal vehicle control inputs to generate actuator commands in consideration of vehicle operation phases for various vehicles.

The vehicle actuators 130 are one or more actuators configured to control components of a vehicle integrated with the universal vehicle control interfaces 110. For instance, the vehicle actuators may include actuators for controlling a power-plant of the vehicle (e.g., an engine). Furthermore, the vehicle actuators 130 may vary depending on the particular vehicle. For example, if the vehicle is a rotorcraft the vehicle actuators 130 may include actuators for controlling lateral cyclic, longitudinal cyclic, collective, and pedal controllers of the rotorcraft. As another example, if the vehicle is a fixed-wing aircraft the vehicle actuators 130 may include actuators for controlling a rudder, elevator, ailerons, and power-plant of the fixed-wing aircraft. In another example, the vehicle actuators 130 include actuators for controlling locks of the vehicle doors.

The vehicle sensors 140 are sensors configured to capture corresponding sensor data. In various embodiments the vehicle sensors 140 may include, for example, one or more global positioning system (GPS) receivers, inertial measurement units (IMUs), accelerometers, gyroscopes, magnometers, pressure sensors (altimeters, static tubes, pitot tubes, etc.), temperature sensors, vane sensors, range sensors (e.g., laser altimeters, radar altimeters, lidars, radars, ultrasonic range sensors, etc.), terrain elevation data, geographic data, airport or landing zone data, rotor revolutions per minute (RPM) sensors, manifold pressure sensors, fuel level sensors, oil level sensors, battery level sensors, cameras (e.g., externally or internally mounted), or other suitable sensors. In some cases, the vehicle sensors 140 may include, for example, redundant sensor channels for some or all of the vehicle sensors 140. The vehicle control and interface system 100 may use data captured by the vehicle sensors 140 for various processes. By way of example, the universal vehicle control router 120 may use vehicle sensor data captured by the vehicle sensors 140 to determine an estimated state of the vehicle.

The data store 150 is a database storing various data for the vehicle control and interface system 100. For instance, the data store 150 may store sensor data (e.g., captured by the vehicle sensors 140), vehicle models, vehicle metadata, or any other suitable data. In addition, it is noted that in some embodiments, vehicle components (e.g., systems, actuators, sensors, etc.) that are subject to a pre-operational check may include a component code in a memory and processing system. The component code may include an identifier and/or other firmware code set that may be used as a part of a security and/or confirmation sign off for a check. For example, the on-board system and/or client device may connect with the vehicle component and perform a software handshake to confirm the component being tested and other details such as time, place and person conducting check, and the information from that processing may be stored in a database, e.g., the data store 150. In this example, security may be introduced via, for example, a handshake that may be a function of only an authorized user was authorized to do the check. The authorized user may be confirmed via a sign in process through a graphical user interface and a back-end database check of credentials of the authorized user (e.g., a licensed aircraft operator and/or mechanic). Moreover, the code component and/or unique identifier corresponding to the system component allows for confirmation of authorized components that were installed as being checked.

Referring now to FIG. 2, it illustrates an example configuration 200 for a set of universal vehicle control interfaces in a vehicle, in accordance with one or more embodiments. The vehicle control interfaces in the configuration 200 may be embodiments of the universal vehicle control interfaces 110, as described above with reference to FIG. 1. In the embodiment shown, the configuration 200 includes a vehicle state display 210, a side-stick inceptor device 240, and a vehicle operator field of view 250. In other embodiments, the configuration 200 may include different or additional elements. Furthermore, the functionality may be distributed among the elements in a different manner than described.

The vehicle state display 210 is one or more electronic displays (e.g., liquid-crystal displays (LCDs) configured to display or receive information describing a state of the vehicle including the configuration 200. In particular, the vehicle state display 210 may display various interfaces including feedback information for an operator of the vehicle. In this case, the vehicle state display 210 may provide feedback information to the operator in the form of virtual maps, 3D terrain visualizations (e.g., wireframe, rendering, environment skin, etc.), traffic, weather, engine status, communication data (e.g., air traffic control (ATC) communication), guidance information (e.g., guidance parameters, trajectory), and any other pertinent information. Additionally, or alternatively, the vehicle state display 210 may display various interfaces for configuring or executing automated vehicle control processes, such as automated aircraft landing or takeoff or navigation to a target location. The vehicle state display 210 may receive user inputs via various mechanisms, such as gesture inputs (as described above with reference to the gesture interface 220), audio inputs, or any other suitable input mechanism.

As depicted in FIG. 2 the vehicle state display 210 includes a primary vehicle control interface 220 and a multi-function interface 230. The primary vehicle control interface 220 is configured to facilitate short-term of the vehicle including the configuration 200. In particular, the primary vehicle control interface 220 includes information immediately relevant to control of the vehicle, such as current universal control input values or a current state of the vehicle. As an example, the primary vehicle control interface 220 may include a virtual object representing the vehicle in 3D or 2D space. In this case, the primary vehicle control interface 220 may adjust the display of the virtual object responsive to operations performed by the vehicle in order to provide an operator of the vehicle with visual feedback. The primary vehicle control interface 220 may additionally, or alternatively, receive universal vehicle control inputs via gesture inputs.

The multi-function interface 230 is configured to facilitate long-term control of the vehicle including the configuration 200. In particular, the primary vehicle control interface 220 may include information describing a mission for the vehicle (e.g., navigation to a target destination) or information describing the vehicle systems. Information describing the mission may include routing information, mapping information, or other suitable information. Information describing the vehicle systems may include engine health status, engine power utilization, fuel, lights, vehicle environment, or other suitable information. In some embodiments, the multi-function interface 230 or other interfaces enable mission planning for operation of a vehicle. For example, the multi-function interface 230 may enable configuring missions for navigating a vehicle from a start location to a target location. In some cases, the multi-function interface 230 or another interface provides access to a marketplace of applications and services. The multi-function interface 230 may also include a map, a radio tuner, or a variety of other controls and system functions for the vehicle.

In some embodiments, the vehicle state display 210 includes information describing a current state of the vehicle relative to one or more control limits of the vehicle (e.g., on the primary vehicle control interface 220 or the multi-function interface 230). For example, the information may describe power limits of the vehicle or include information indicating how much control authority a use has across each axis of movement for the vehicle (e.g., available speed, turning ability, climb or descent ability for an aircraft, etc.). In the same or different example embodiment, the vehicle state display 210 may display different information depending on a level of experience of a human operator of the vehicle. For instance, if the vehicle is an aircraft and the human operator is new to flying, the vehicle state display may include information indicating a difficulty rating for available flight paths (e.g., beginner, intermediate, or expert). The particular experience level determined for an operator may be based upon prior data collected and analyzed about the human operator corresponding to their prior experiences in flying with flight paths having similar expected parameters. Additionally, or alternatively, flight path difficulty ratings for available flight paths provided to the human operator may be determined based on various information, for example, expected traffic, terrain fluctuations, airspace traffic and traffic type, how many airspaces and air traffic controllers along the way, or various other factors or variables that are projected for a particular flight path. Moreover, the data collected from execution of this flight path can be fed back into the database and applied to a machine learning model to generate additional and/or refined ratings data for the operator for subsequent application to other flight paths. Vehicle operations may further be filtered according to which one is the fastest, the most fuel efficient, or the most scenic, etc.

The one or more vehicle state displays 210 may include one or more electronic displays (e.g., liquid-crystal displays (LCDs), organic light emitting diodes (OLED), plasma). For example, the vehicle state display 210 may include a first electronic display for the primary vehicle control interface 220 and a second electronic display for the multi-function interface 230. In cases where the vehicle state display 210 include multiple electronic displays, the vehicle state display 210 may be configured to adjust interfaces displayed using the multiple electronic displays, e.g., in response to failure of one of the electronic displays. For example, if an electronic display rendering the primary vehicle control interface 220 fails, the vehicle state display 210 may display some or all of the primary vehicle control interface 220 on another electronic display.

The one or more electronic displays of the vehicle state display 210 may be touch sensitive displays is configured to receive touch inputs from an operator of the vehicle including the configuration 200, such as a multi-touch display. For instance, the primary vehicle control interface 220 may be a gesture interface configured to receive universal vehicle control inputs for controlling the vehicle including the configuration 200 via touch gesture inputs. In some cases, the one or more electronic displays may receive inputs via other type of gestures, such as gestures received via an optical mouse, roller wheel, three-dimensional (3D) mouse, motion tracking device (e.g., optical tracking), or any other suitable device for receiving gesture inputs.

Touch gesture inputs received by one or more electronic displays of the vehicle state display 210 may include single finger gestures (e.g., executing a predetermined pattern, swipe, slide, etc.), multi-finger gestures (e.g., 2, 3, 4, 5 fingers, but also palm, multi-hand, including/excluding thumb, etc.; same or different motion as single finger gestures), pattern gestures (e.g., circle, twist, convergence, divergence, multi-finger bifurcating swipe, etc.), or any other suitable gesture inputs. Gesture inputs can be limited asynchronous inputs (e.g., single input at a time) or can allow for multiple concurrent or synchronous inputs. In variants, gesture input axes can be fully decoupled or independent. In a specific example, requesting a speed change holds other universal vehicle control input parameters fixed—where vehicle control can be automatically adjusted in order to implement the speed change while holding heading and vertical rate fixed. Alternatively, gesture axes can include one or more mutual dependencies with other control axes. Unlike conventional vehicle control systems, such as aircraft control systems, the gesture input configuration as disclosed provides for more intuitive user experiences with respect to an interface to control vehicle movement.

In some embodiments, the vehicle state display 210 or other interfaces are configured to adjust in response to vehicle operation events, such as emergency conditions. For instance, in response to determining the vehicle is in an emergency condition, the vehicle control and interface system 100 may adjust the vehicle state display 210 to include essential information or remove irrelevant information. As an example, if the vehicle is an aircraft and the vehicle control and interface system 100 detects an engine failure for the aircraft, the vehicle control and interface system 100 may display essential information on the vehicle state display 210 including 1) a direction of the wind, 2) an available glide range for the aircraft (e.g., a distance that the aircraft can glide given current conditions), or 3) available emergency landing spots within the glide range. The vehicle control and interface system 100 may identify emergency landing locations using various processes, such as by accessing a database of landing spots (e.g., included in the data store 150 or a remote database) or ranking landing spots according to their suitability for an emergency landing.

The side-stick inceptor device 240 may be a side-stick inceptor configured to receive universal vehicle control inputs. In particular, the side-stick inceptor device 240 may be configured to receive the same or similar universal vehicle control inputs as a gesture interface of the vehicle state display 210 is configured to receive. In this case, the gesture interface and the side-stick inceptor device 240 may provide redundant or semi-redundant interfaces to a human operator for providing universal vehicle control inputs. The side-stick inceptor device 240 may be active or passive. Additionally, the side-stick inceptor device 240 and may include force feedback mechanisms along any suitable axis. For instance, the side-stick inceptor device 240 may be a 3-axis inceptor, 4-axis inceptor (e.g., with a thumb wheel), or any other suitable inceptor.

The components of the configuration 200 may be integrated with the vehicle including the configuration 200 using various mechanical or electrical components. These components may enable adjustment of one or more interfaces of the configuration 200 for operation by a human operator of the vehicle. For example, these components may enable rotation or translation of the vehicle state display 210 toward or away from a position of the human operator (e.g., a seat where the human operator sits). Such adjustment may be intended, for example, to prevent the interfaces of the configuration 200 from obscuring a line of sight of the human operator to the vehicle operator field of view 250.

The vehicle operator field of view 250 is a first-person field of view of the human operator of the vehicle including the configuration 200. For example, the vehicle operator field of view 250 may be a windshield of the vehicle or other suitable device for enabling a first-person view for a human operator.

The configuration 200 additionally or alternately include other auxiliary feedback mechanisms, which can be auditory (e.g., alarms, buzzers, etc.), haptic (e.g., shakers, haptic alert mechanisms, etc.), visual (e.g., lights, display cues, etc.), or any other suitable feedback components. Furthermore, displays of the configuration 200 (e.g., the vehicle state display 210) can simultaneously or asynchronously function as one or more of different types of interfaces, such as an interface for receiving vehicle control inputs, an interface for displaying navigation information, an interface for providing alerts or notifications to an operator of the vehicle, or any other suitable vehicle instrumentation. Furthermore, portions of the information can be shared between multiple displays or configurable between multiple displays.

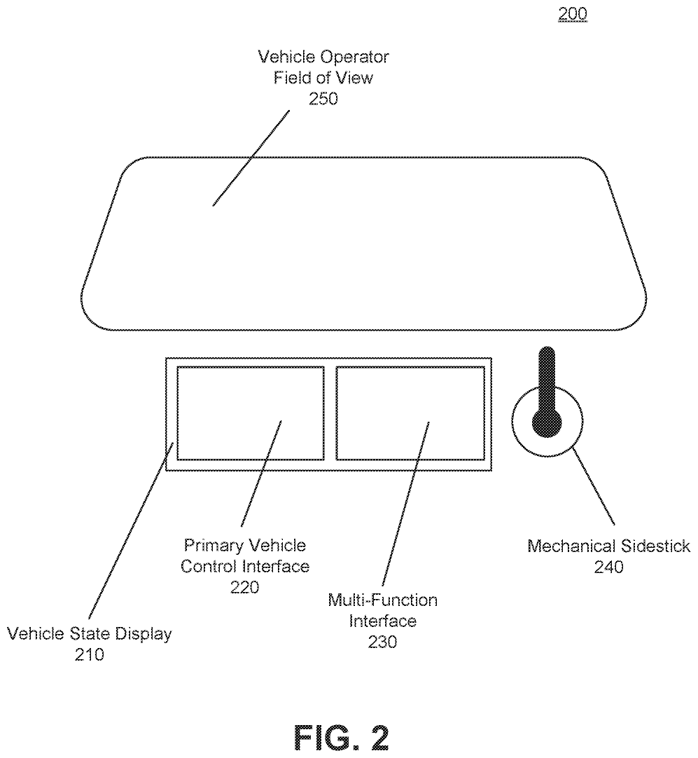

As described above, the vehicle controls and interfaces can be used to control vehicles, such as aircraft in an aerial network. An example aerial network is described below with respect to FIG. 3. Furthermore, operation of a vehicle (e.g., aircraft) using the above-described vehicle controls and interfaces may be conditioned on a pre-operational checklist (e.g., preflight checklist). In some embodiments, the above-described vehicle controls and interfaces are used to complete checks of a pre-operational checklist (e.g., to check the operational status of a component). Additionally, or alternatively, the vehicle controls and interfaces may be used to remotely monitor a vehicle (e.g., aircraft). For example, if an aircraft control interface includes a camera facing the inside the cockpit, a remote user may be able to access the video feed of the camera using a client device. Similarly, if a vehicle includes an external facing camera or a camera mounted to the outside of the vehicle, a remote user may be able to access the video feed of any of these cameras.

### Example Aerial Network

FIG. 3 is a block diagram of an aerial network 300 for generating and providing customized preflight checklist GUIs and remotely monitoring an aircraft, in accordance with one or more embodiments. The aerial network 300 includes an aircraft management module 330, multiple aircraft 340A-C, a client device 350 (or multiple client devices), and a network 320. The aerial network 300 can include different components than those illustrated. Although the description herein refers to an aerial network, embodiments may be relevant to networks associated with other types of vehicles. For example, embodiments may be relevant to land vehicles.

An aircraft (e.g., 340A) is a vehicle configured to fly and operates in the aerial network 300. Example aircraft include manned aircraft, unmanned aircraft (UAV), rotorcraft, and fixed wing aircraft. An aircraft may be a fly-by-wire (FBW) aircraft (e.g., as described with respect to FIGS. 1-2) or an aircraft which relies on conventional manual flight controls. The aircraft may operate autonomously, semi-autonomously (e.g., by an autopilot or guidance and navigation system aided by a human operator), or manually. An aircraft may be associated with a unique aircraft identifier, which is stored in a database (e.g., at the management module 330). The aircraft identifier may be stored in response to registration of the aircraft within the aerial network 300. The identifiers may be tail numbers of the aircraft, such as aircraft registration numbers (e.g., for civil aircraft) or military aircraft serial numbers (e.g., for military aircraft). Pilots may additionally, or alternatively, have unique identifiers as well (e.g., stored in a database).

The management module 330 may facilitate interactions between the client device 350 and the aircraft 340A-C in the aerial network 300. For example, the management module 330 may store the locations, sensor data, maintenance history, software version, database version, flight and fault logs, configuration, and identifiers of each of the aircraft within the aerial network 300. It also may store identification and/or handshake data associated with specific components of the aircraft that are tested or checked. In some embodiments, each aircraft (e.g., regularly) communicates data with the management module 330, the management module 330 maintains a list of which aircraft are available (based on the data communications), and the management module 330 provides relevant data about the aircraft to requesting client devices (e.g., 350).

The management module 330, aircraft 340A-C, and client device 350 are configured to communicate via the network 320, which may comprise any combination of local area and wide area networks, using both wired and wireless communication systems. In one embodiment, the network 320 uses standard communications technologies and protocols. For example, the network 320 includes communication links using technologies such as satellite communication, radio, vehicle-to-infrastructure (“V2I”) communication technology, Ethernet, 802.11, worldwide interoperability for microwave access (WiMAX), 3G, 4G, code division multiple access (CDMA), digital subscriber line (DSL), etc. Examples of networking protocols used for communicating via the network 320 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 320 may be represented using any suitable format, such as hypertext markup language (HTML) or extensible markup language (XML). In some embodiments, all or some of the communication links of the network 320 may be encrypted using any suitable technique or techniques.

The client device 350 is one or more computing devices capable of receiving user input as well as transmitting or receiving data via the network 320. In one embodiment, a client device 350 is a computer system, such as a desktop or a laptop computer. Alternatively, a client device 350 may be a device having computer functionality, such as a personal digital assistant (PDA), a mobile telephone, a smartphone, or another suitable device. A client device 350 is configured to communicate via the network 320. In one embodiment, a client device 350 executes an application allowing a user of the client device 350 to interact with the management module 330 or an aircraft (e.g., 340A). For example, a client device 350 executes a browser application to enable interaction between the client device 350 and aircraft 340A via the network 320. In another embodiment, a client device 350 interacts with the management module 330 or an aircraft through an application programming interface (API) running on a native operating system of the client device 350, such as APPLE IOS® or GOOGLE ANDROID™.

In the example of FIG. 3, the client device 350 includes a selection module 355, a data receiver module 360, a checklist GUI module 365, a validator module 370, and an authorization module 375. In some embodiments, the client device 350 includes different modules, and the functionalities of the modules may be distributed among the modules in a different manner than described. Any of the modules may be part of the management module 330 instead of the client device 350. The client device 350 may be physically separate from any aircraft. In other embodiments the client device may be part of an aircraft (e.g., 340A). For example, a preflight checklist GUI is displayed by on a screen or display (e.g., display 210) mounted to a dashboard of an aircraft.

The selection module 355 provides functionality for a user of the client device 350 to select an aircraft to be piloted by the user. For example, the selection module 355 displays (via the client device) images of aircraft that are available for piloting by the user and receives a selection of an aircraft by the user (e.g., responsive to the user reviewing the displayed set of aircraft). The user may select an aircraft by interacting with a display of the client device 350 (e.g., touching an image of the aircraft) or by other input means (e.g., using a keyboard or mouse). In some embodiments, the user selects a specific aircraft (e.g., associated with a unique identifier) to pilot. In other embodiments, the user selects a type of aircraft (e.g., a monoplane) and the selection module 355 selects a specific aircraft of that type that is available for the user to pilot.

Before the set of available aircraft are displayed, the selection module 355 may determine which aircraft are available or receive a list of available aircraft. For example, the management module 330 maintains a log of available aircraft. In this example, the selection module 355 may receive (e.g., via retrieval) the list when a user wants to select an aircraft. The available aircraft may be based on one of more factors, such as aircraft located at a specified location (e.g., airport), the current time, a time when the user desires to fly, weather conditions (e.g., the available aircraft are capable of flying through the weather conditions), the user's piloting experience, mission parameters of the user (e.g., passengers to carry, distance to travel, or task to perform), or the user's piloting credentials. In some embodiments, the selection module 355 (or management module 330) transmits a request to a set of aircraft to provide their availability.

The data receiver module 360 receives the aircraft selection from the selection module 355 and retrieves sensor data generated by one or more sensors (e.g., vehicle sensors 140) of the selected aircraft. As previously described, one or more sensors (e.g., vehicle sensors 140) may be coupled to an aircraft to measure various quantities. Generally, the data receiver module 360 retrieves sensor data that is helpful for completing a preflight checklist. For example, the data receiver module 360 determines which sensors the selected aircraft includes and retrieves data (from one or more of the sensors) that is helpful for completing a preflight checklist. For example, the data receiver module 360 retrieves data generated by a fuel sensor configured to measure a fuel level, an oil sensor configured to measure an oil level. Additional example sensors include a seat sensor that measures the passenger weight and presence of a passenger, an OAT (outside air temperature) sensor for remote monitoring purposes, a voltage sensor to measure the battery, a sensor that determines whether or not ground power is connected, an internal and/or external camera, and a position sensor (e.g., GPS) that provides the location of the aircraft.

The data may be generated after the user selects the aircraft (e.g., data is generated responsive to a request from the data receiver module 360) or before the user selects the aircraft (e.g., sensor data is periodically generated and stored). The data receiver module 360 may retrieve sensor data from the selected aircraft or from the management module 330 depending on where the sensor date is stored. Since the data is used to help complete preflight checks, it may be preferable for the data to reflect the current state or a recent state of the aircraft. For example, the retrieved data includes data generated most recently by a sensor (e.g., the latest batch of data generated by a sensor), or data generated by a sensor within a threshold amount of time from the current time.

In some embodiments, the power supply determines which sensors of an aircraft are active. For example, if an aircraft is coupled to ground power, first set of sensors may be powered to generate data, but if the aircraft is using a dedicated battery (instead of the ground power) a different set of sensors may be powered to generate data (e.g., a set of sensors that consumes less power).

The checklist GUI module 365 may be configured to maintain a preflight checklist and display the preflight checklist in a GUI (“preflight checklist GUI”) on a screen or display of the client device 350. In some embodiments, the client device 350 (or the management module 330) includes a checklist store that stores preflight checklists for different aircraft. In these embodiments, the checklist GUI module 365 may retrieve a checklist from the store based on the aircraft selection. The checklist GUI module 365 may only present a portion of the GUI at any given time instead of the entire preflight checklist GUI (e.g., due to the client device 350 having limited display space).

The preflight checklist GUI includes preflight checks to be performed. For example, the preflight checklist GUI includes preflight checks that instruct the user to (e.g., visually) inspect exterior and interior portions of the aircraft (e.g., for damage or mechanical integrity). The preflight checklist GUI may also include instructions for how to complete the preflight checks. The instructions may be in, for example, a video popup or a text popup displayed on the screen and may further include step by step screens or series of screens to follow to complete the check process. Thus, after the preflight checklist GUI is displayed, the user may reference the preflight checklist GUI to perform the preflight checks. The user may also interact with the preflight checklist GUI. For example, after a preflight check is completed, the user can provide input to the preflight checklist GUI to indicate the check was completed. If there is an issue with any portion of the check, the system may be configured with an interface button that auto signals or auto generates and transmits a message for help, e.g., to a control system or help desk. The message may include, for example, the aircraft identifier, the system component identifier, and the check being performed.

Among other advantages, the checklist GUI module 365 may create a customized preflight checklist GUI specific to the selected aircraft. For example, the checklist GUI module 365 updates a preflight checklist GUI based on the selected aircraft (from the selection module 355) or sensor data (from the data receiver module 360). This may help the user perform a preflight check that is relevant to the selected aircraft (instead of referencing a generic preflight checklist). For example, the custom preflight checklist GUI includes preflight checks specific to a type (e.g., make or model) of the selected aircraft. In some embodiments, checklist GUI module 365 creates a customized preflight checklist GUI that is unique for the selected aircraft. For example, if a frame of the selected aircraft includes a dent, the customized preflight checklist GUI may include a preflight check that includes an indication of the location of the dent and an instruction to inspect the dent (e.g., to confirm the integrity of the frame). In another example, if a component of the selected aircraft recently underwent a maintenance action, the customized preflight checklist GUI may include a preflight check that includes an instruction to inspect the recently repaired component.

As noted previously, to help a user complete preflight checks, a customized preflight checklist GUI may include one or more text, images, or videos of the selected aircraft. For example, the one or more images may include an image of the actual aircraft being inspected by the user, an image of a same type of aircraft, or some combination thereof. These images may help the user identify the aircraft in the environment and perform the preflight checks. In another example, if a user should inspect an exterior portion of the aircraft (e.g., inspect a wing or rotor blade for damage), the customized preflight checklist GUI may include an image of the entire aircraft with an indicator indicating the location of the exterior portion to be inspected or it may include a zoomed in image of the exterior portion. In another example, the preflight checklist GUI may include an animated or abstracted visual that guides the user to an area of the aircraft to be inspected.

In some embodiments, a customized preflight checklist GUI allows a user to review maintenance records of the selected aircraft. For example, the checklist GUI module 365 retrieves maintenance records of the selected aircraft (e.g., maintenance records associated with the aircraft identifier of the aircraft), and the customized GUI enables the user to review the records. In this case, a preflight check may instruct the user to review the maintenance records for accuracy or to confirm they are up to date.

In some embodiments, the user can interact with the aircraft by interacting with a customized preflight checklist GUI. In these embodiments, the client device 350 may transmit operational instructions to the selected aircraft after the user interacts with the customized preflight checklist GUI. These operational instructions may help the user perform checks of the checklist. For example, if a preflight check instructs a user to confirm the anti-collision lights are functional, the customized GUI may enable the user to turn the lights on. More specifically, after the user selects a “check anti-collision lights” button in the preflight checklist GUI, the client device 350 may transmit an instruction to the aircraft to turn on the anti-collision lights. Thus, the user can check the anti-collision lights without physically entering the aircraft and manually turning on the anti-collision lights. Other example operational instructions that may help the user perform preflight checks include transmitting (e.g., prefilled) aspects of the flight plan or the aircraft configuration, such as weight and balance inputs.

Additionally, or alternatively, the checklist GUI module 365 may create a customized preflight checklist GUI based on sensor data retrieved by module 360. For example, the customized preflight checklist GUI includes information derived from the sensor data and a preflight check associated with the information. To give a specific example, if the sensor data includes a fuel level of the aircraft, the customized preflight checklist GUI may include a preflight check that displays the fuel level and instructs the user to confirm the fuel is above a (e.g., predetermined) threshold level (e.g., sufficient for the aircraft to fly to a destination). In similar examples, if the sensor data includes an oil level or battery energy level of the aircraft, the customized GUI may include a preflight check that displays the oil level or energy level (and optionally instructs the user to review the level).

In some embodiments, a preflight checklist GUI includes a preflight check that instructs the user to capture an image of the aircraft or a portion of the aircraft. For example, a preflight check instructs a user to capture images of damage to the aircraft. These images may help create or maintain a maintenance record of the aircraft. These images may be saved and displayed later (e.g., during a future preflight checklist GUI). However, while instructing a user to capture images can help the user to identify aircraft damage and while taking photos of damage can help catalog the damage, as previously stated, the user is still responsible for ensuring the aircraft is flightworthy before piloting the aircraft.

In some embodiments, the following feature may be implemented: the user is not authorized to access the interior of the aircraft until a set of preflight checks associated with the exterior of the aircraft are completed (e.g., and/or validated). After the exterior checks are complete, the user may receive authorization to access the interior and proceed to complete a set of preflight checks associated with the interior of the aircraft. For example, after the exterior preflight checks are complete, the authorization module 375 sends an authorization (e.g., to the management module 330 or the aircraft being inspected) that allows the user to enter the aircraft (e.g., the aircraft doors become unlocked). Note that the embodiments described in this paragraph may be subject to safety considerations and other considerations (e.g., practicality). For example, a user with a key to an aircraft may always be able to access the interior of the aircraft.

In some embodiments, the user can interact with a technician (e.g., engineer, mechanic, or software specialist) through the customized GUI. For example, the GUI includes a call or message feature. Interacting with a technician may be helpful if, for example, the user has a question about a preflight check or if, for example, one of the components of the aircraft are not functioning properly.

The user may provide input to the customized preflight checklist GUI to indicate completion of one or more preflight checks. After the input is received (e.g., responsive to the input), the validator module 370 may validate completion of one or more of the completed preflight checks. The validation may be based on sensor data. For example, if the user confirms a fuel level is sufficient, the validator module 370 may independently confirm the fuel level is sufficient (e.g., based on fuel consumption rate estimates and distance to the destination). In another example, if the user confirms a brake (e.g., a rotor brake) is released, the validator module 370 may reference data from a sensor of the brake to validate the brake is released. In some embodiments, the validator module 370 determines whether the client device 350 is within a threshold distance (e.g., 10 meters) of the selected aircraft or another relevant point of interest, such as a hangar with the aircraft is stored. This may help confirm that the user is performing the preflight checks (e.g., instead of the user ‘clicking through’ the checklist without actually performing the checks).

The authorization module 375 determines when each of the preflight checks are completed (e.g., and/or validated). If each preflight check is completed and validated, the authorization module 375 sends an authorization to the selected aircraft (e.g., via management module 330) that authorizes the user to pilot the aircraft (the management module 330 may also be informed of the authorization). Additionally, in some embodiments, the authorization is sent if the authorization module 375 determines the client device 350 is within a threshold distance (e.g., 10 meters) of the selected aircraft or another relevant point of interest, such as a hangar where the aircraft is stored. This may help ensure the user is near the aircraft and ready to pilot the aircraft. In some cases, the user is not allowed to pilot or cannot pilot the aircraft until the authorization is transmitted (e.g., and/or processed). For example, the doors of the aircraft remain locked or the aircraft engine won't start until the authorization is received. In another example, the aircraft turns on but won't takeoff (this may be useful if any preflight checks relate to starting the engine). In some cases, a pilot can forgo completing one or more preflight checks before piloting an aircraft. For example, a pilot may forgo completing one or more preflight checks if they completed the one or more preflight checks within a threshold period of time (e.g., earlier in the day) or if the pilot is in an extreme hurry (e.g., a lifeflight pilot will pilot the aircraft to respond to an emergency).

In some embodiments, only a subset of the preflight checks is completed for the user to pilot the aircraft. In these embodiments, after a set (e.g., a predetermined subset) of the preflight checks are completed, the authorization module 375 may provide the authorization. For example, a preflight checklist GUI may include “necessary” preflight checks and “optional” preflight checks. In this case, the authorization module 375 may provide authorization after the “necessary” preflight checks are completed (e.g., and validated).

In some embodiments, the client device 350 can be used to remotely monitor an aircraft. For example, after a user has selected an aircraft using the selection module 355, the user may indicate types of quantities associated with the aircraft they wish to monitor. The data receive module 360 may then send a data request to the aircraft. The aircraft may check the quantities specified in the data request (e.g., by retrieving sensor data) and send a response to the client device.

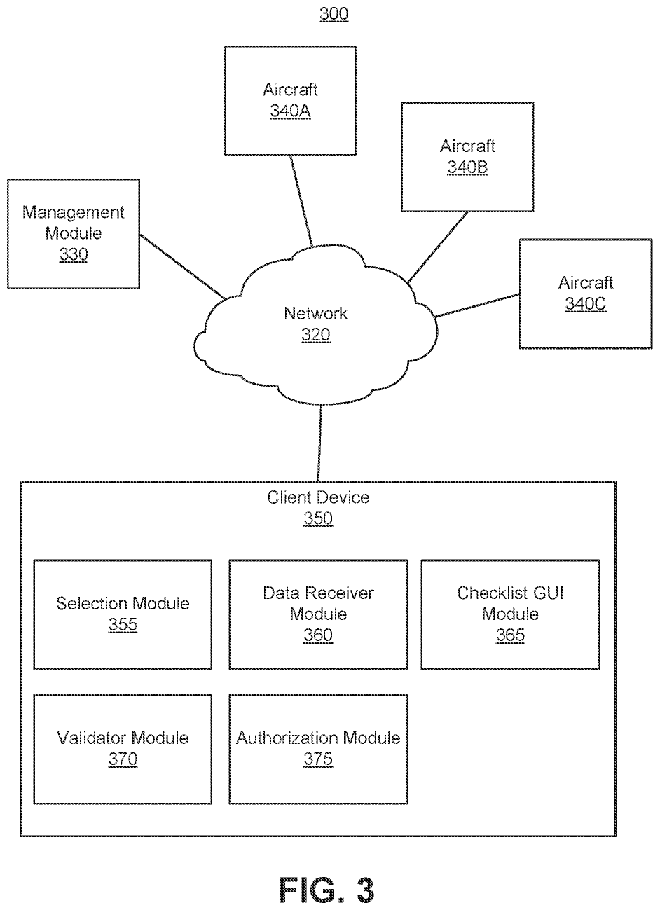

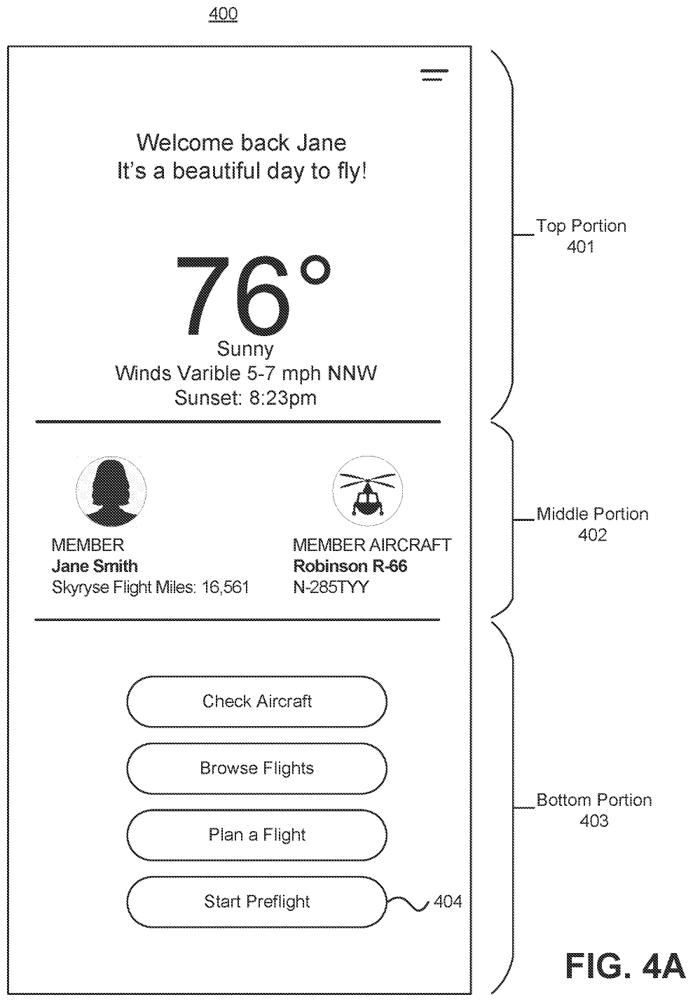

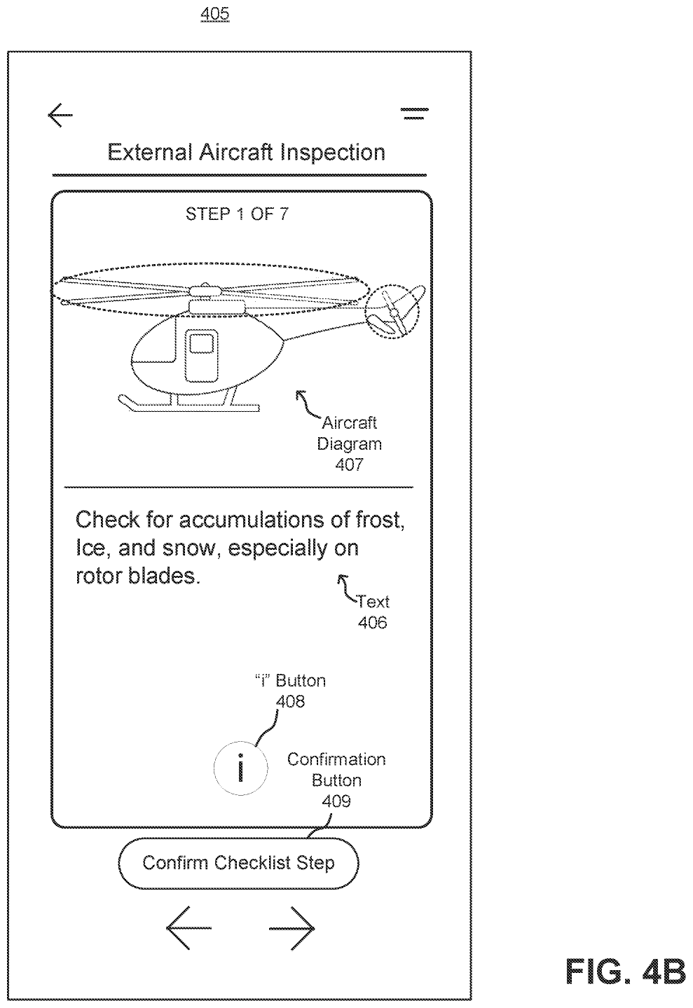

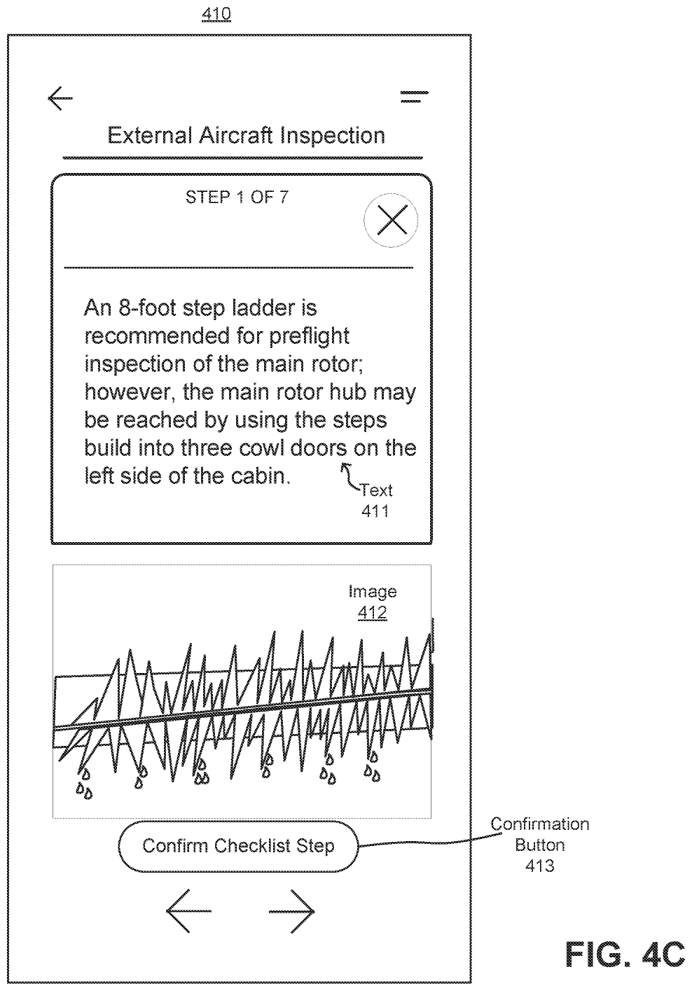

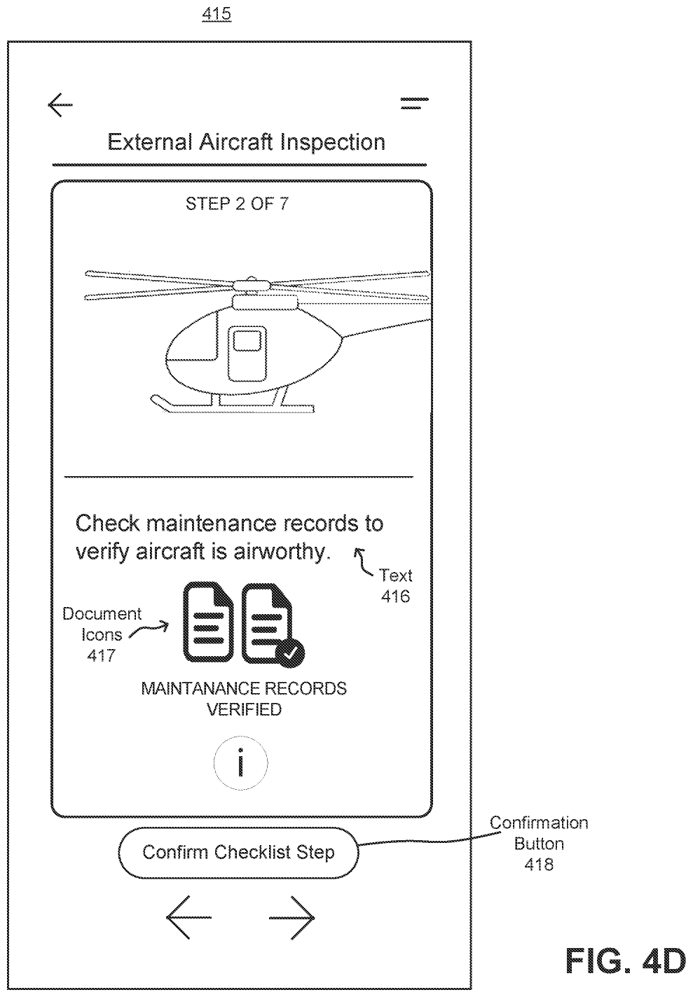

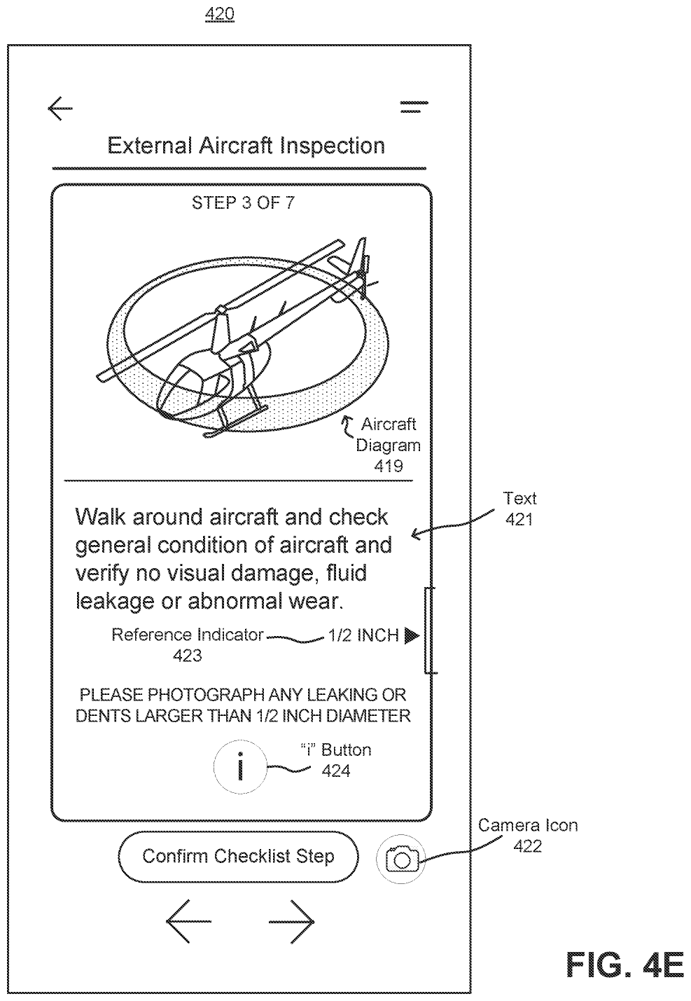

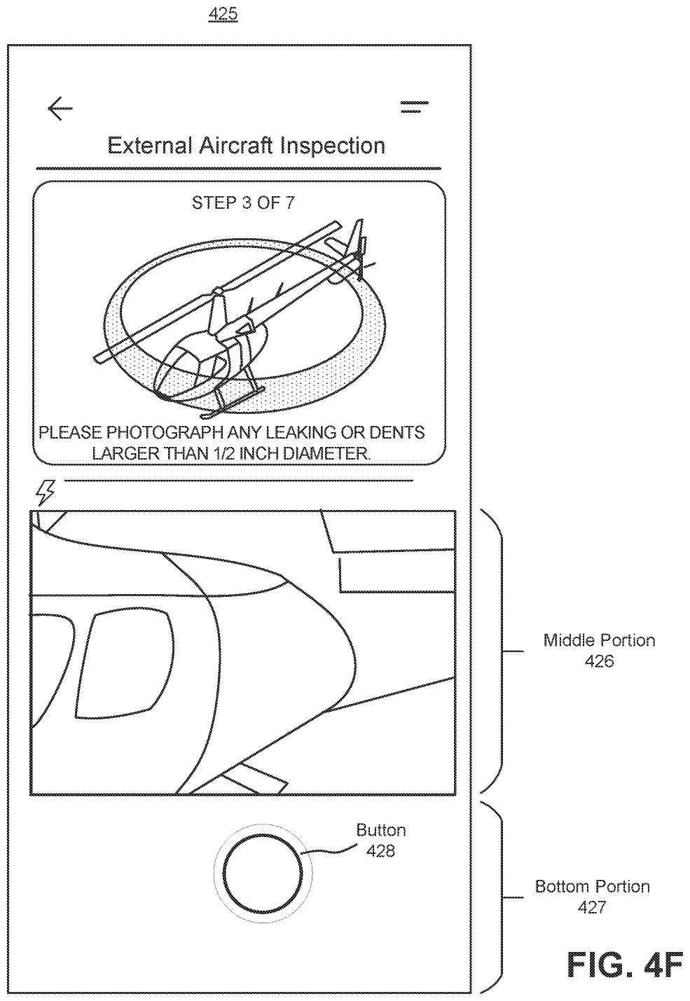

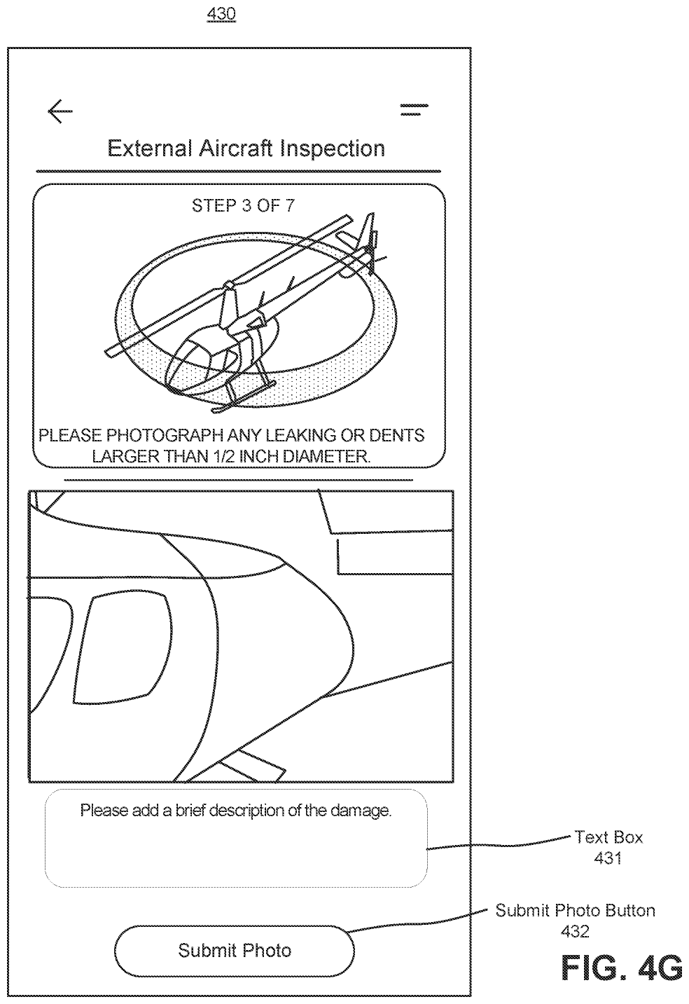

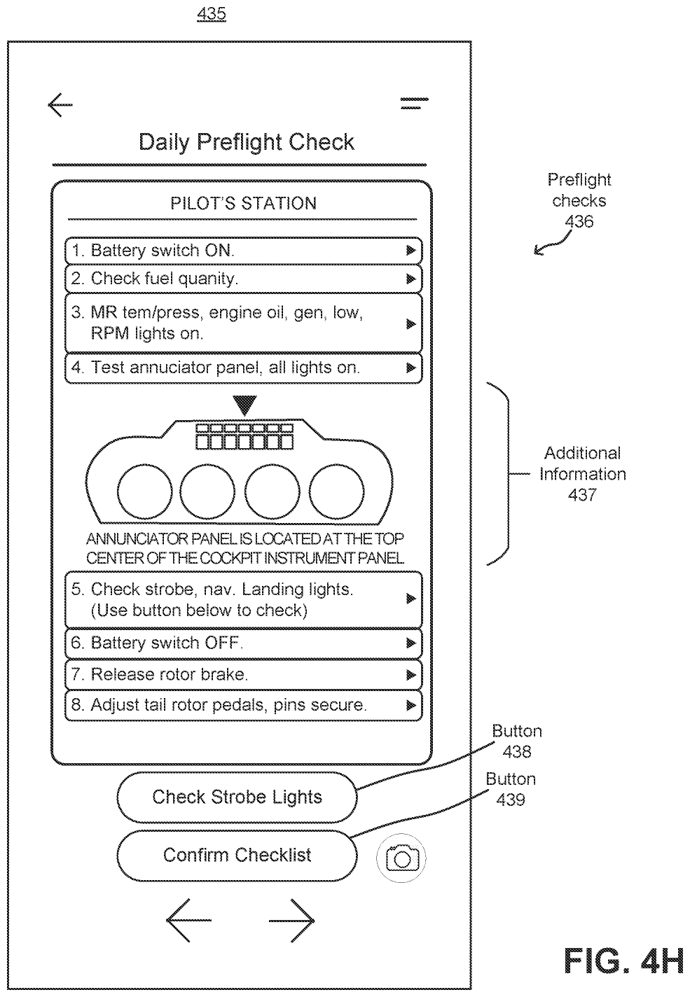

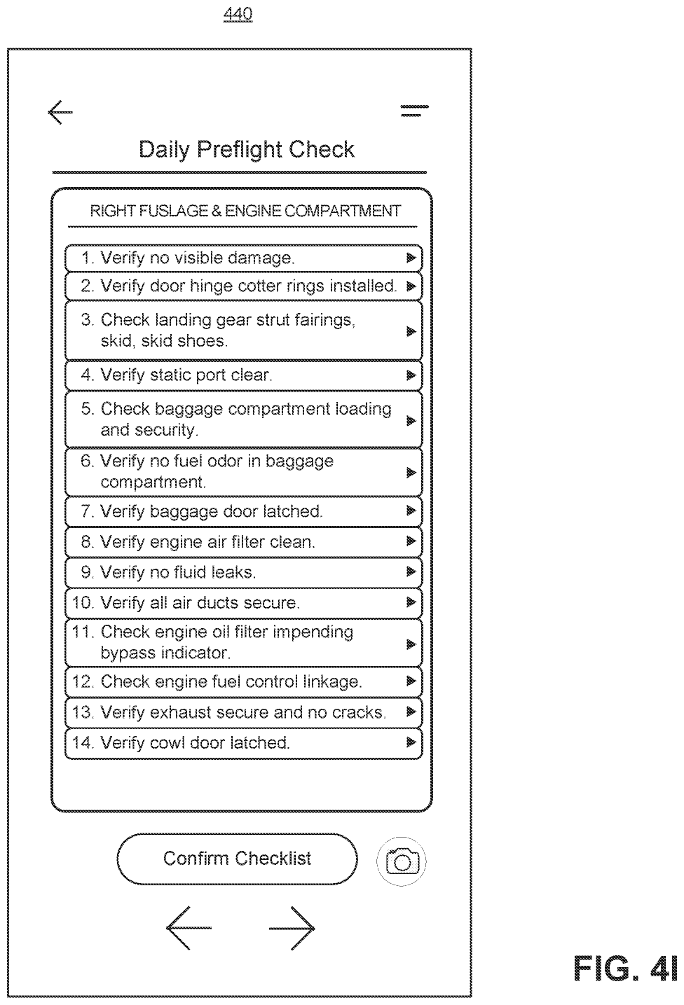

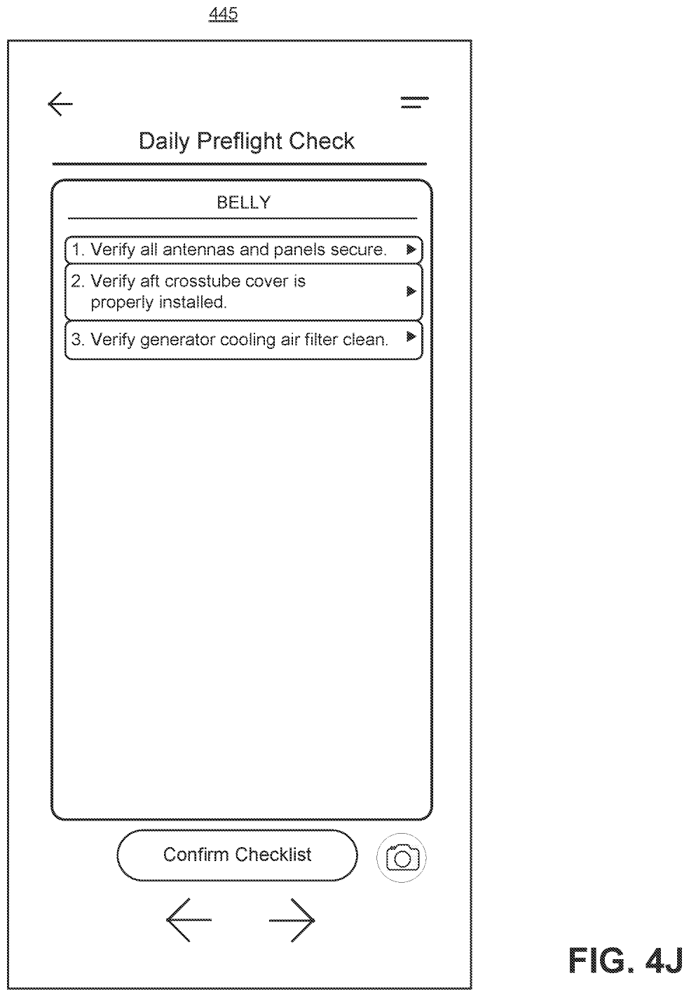

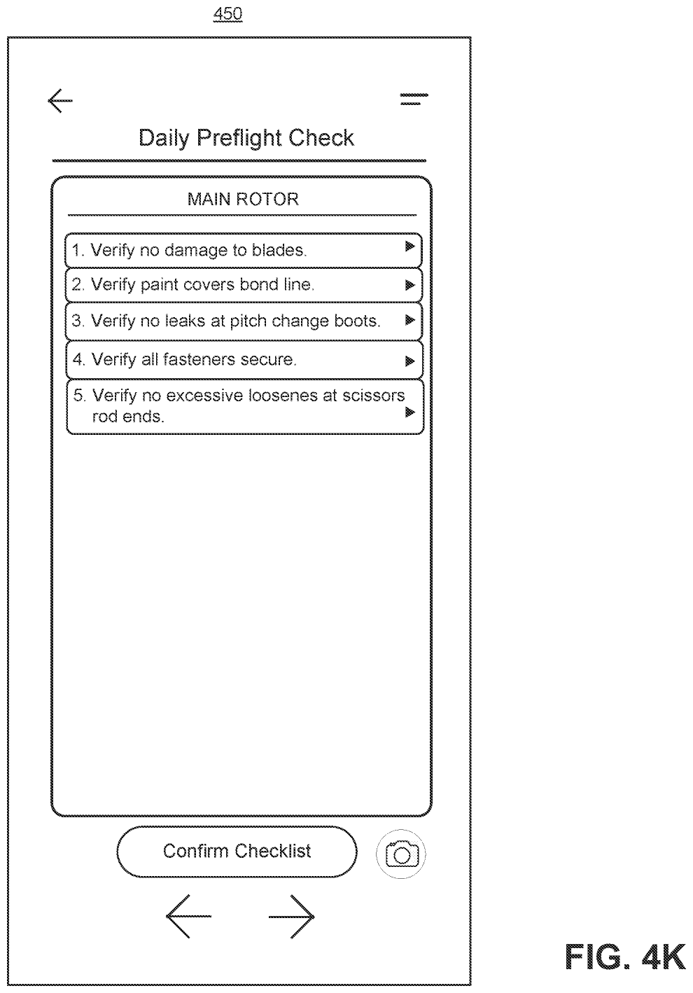

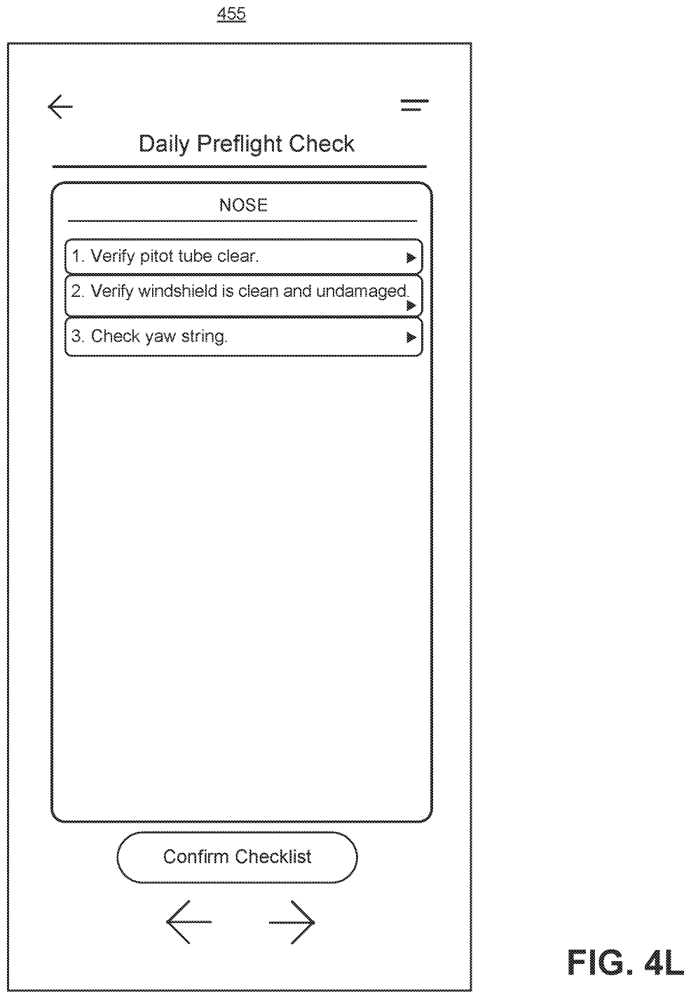

FIG. 4A is a screenshot 400 of a GUI welcome screen that may be displayed by a client device (e.g., 350), in accordance with one or more embodiments. A top portion 401 of the screenshot 400 describes the current weather, the middle portion 402 provides details of the user (“Jane Smith”) and an aircraft associated with the user (a Robinson R-66 helicopter) (e.g., previously selected by the user). The bottom portion 403 includes buttons the user can select. For example, the user can view a customized preflight checklist GUI by selecting the “Start Preflight” button 404.

FIGS. 4B-4G are screenshots of portions of a customized checklist GUI that may be displayed by a client device (e.g., 350). For example, the screenshots may be displayed by mobile application running on a smartphone. As previously described, a customized checklist GUI may be customized based on the selected aircraft or sensor data from the selected aircraft. A screenshot of the customized checklist GUI may include one or more preflight checks. Specifically, the screenshot generally includes text explaining a preflight check, a diagram or image to help the user understand the preflight check, and a button to select after the preflight check has been performed. In some cases, a screenshot includes an “i” button used to receive more information on the preflight check or a camera icon used to capture images. These features are further described below.

FIG. 4B is a screenshot 405 of the customized preflight checklist GUI, in accordance with one or more embodiments. A client device may display screenshot 405 in response to the user selecting the “Start Preflight” button in FIG. 4A. The screenshot 405 includes a preflight check. Specifically, the screenshot 405 includes text 406 instructing the user to inspect the aircraft for accumulations of frost, ice, and snow. The screenshot 405 also includes a side view diagram 407 of the aircraft associated with the user. The rotary blades of the aircraft are circled with dotted lines to emphasize the importance of checking the rotor blades for accumulations. The “i” button 408 may be selected if the user desires more information about inspecting for frost, ice, and snow accumulations. The bottom portion of the screenshot 405 includes a button 409 that allows the user the confirm they inspected the aircraft for accumulations.

FIG. 4C is a screenshot 410 of the customized preflight checklist GUI, in accordance with one or more embodiments. The screenshot 410 provides additional information for the preflight check in screenshot 405. A client device may display the screenshot 410 in response to the user selecting the “i” button 408 in FIG. 4B. Specifically, the screenshot 410 includes additional text 411 intended to help the user inspect for accumulations of frost, ice, and snow on the main rotor blades of the aircraft. The screenshot 410 also includes an example image 412 of ice on a rotor blade. This image 412 is intended to show the user what ice accumulation looks like, thus helping the user identify ice on a rotor blade of the aircraft. Button 413 allows the user the confirm they inspected the aircraft for accumulations.

FIG. 4D is a screenshot 415 of the customized preflight checklist GUI, in accordance with one or more embodiments. A client device may display the screenshot 415 in response to the user selecting the “Confirm Checklist Step” button 409 or 413. The screenshot 415 includes another preflight check. Specifically, the screenshot 415 includes text 416 instructing the user to inspect maintenance records of the aircraft. By selecting the document icons 417 in the screenshot 415, the customized preflight checklist GUI may display the maintenance records of the aircraft. Button 418 allows the user the confirm they inspected the maintenance records.

FIG. 4E is a screenshot 420 of the customized preflight checklist GUI, in accordance with one or more embodiments. A client device may display the screenshot 420 in response to the user selecting the “Confirm Checklist Step” button 418 in FIG. 4D. The screenshot 420 includes another preflight check. Specifically, the screenshot 420 includes text 421 instructing the user to perform a visual inspection of the exterior of the aircraft for damage. The user is further instructed to take an image of any leaking or dents larger than ½ an inch in diameter. The screenshot 420 also includes a visual reference indicator 423 on the right side to help the user determine if a leak or dent is larger than ½ an inch. To take a picture, the user may select the camera icon 422 in the lower right portion of the screenshot 420. The “i” button 424 may be selected if the user desires more information about this preflight check. The screenshot 420 also includes a perspective diagram 419 of the aircraft. A circular region around the aircraft is highlighted to indicate the user should walk around the entire aircraft to perform this preflight check.

FIG. 4F is a screenshot 425 of the customized preflight checklist GUI, in accordance with one or more embodiments. A client device may display the screenshot 425 in response to the user selecting the camera icon 422 in FIG. 4E. The screenshot 425 illustrates a camera functionality that allows the user to capture images of the aircraft that include leaks or dents larger than ½ an inch in diameter. The middle portion 426 of the screenshot 425 indicates the field of view of the camera of the client device. In the example of FIG. 4F, the camera is pointing at an exterior portion of the aircraft. The user can capture an image by selecting the circular button 428 at the bottom portion 427 of the screenshot 425.

FIG. 4G is a screenshot 430 of the customized preflight checklist GUI, in accordance with one or more embodiments. A client device may display the screenshot 430 in response to the user capturing an image of the aircraft (e.g., selecting the circular button 428 in FIG. 4F). The screenshot 430 includes a text box 431 that allows the user to describe the image they captured (e.g., to describe a dent or leak in the captured image). The user may submit the image and text by selecting the “Submit Photo” button 432 at the bottom of the screenshot 430.

Other example preflight checks of the customized preflight checklist GUI may be to: (1) inspect the aircraft for fretting at rivets and seams, (2) inspect a tail gearbox to confirm no temperature increases that cannot be attributed to a change in operating conditions, or (3) verify torque stripes on critical fasteners are not broken or missing. As described above, screenshots associated with these preflight checks may allow the user to capture images of damage and request additional information about the preflight checks.

FIGS. 4H-4M are additional screenshots of portions of the customized checklist GUI. FIG. 4H is a screenshot 435 of the customized preflight checklist GUI that includes preflight checks 436 associated with the pilot station of the aircraft, in accordance with one or more embodiments. If a user selects any of the preflight checks, the GUI may present more information. In the example of FIG. 4H, the screenshot 435 is presenting additional information 437 on preflight check 4 (e.g., in response to the user selecting preflight check 4). Additionally, screenshot 435 includes a “Check Strobe Lights” button 438. Subsequent to the user selecting this button 438, the aircraft may be instructed to turn on its strobe lights so the user can confirm those lights are functional. The user may select the “Confirm Checklist” button 439 to confirm they performed the preflight checks in screenshot 435.

FIG. 4I is a screenshot 440 of the customized preflight checklist GUI that includes preflight checks associated with the right fuselage and right engine compartment of the aircraft, in accordance with one or more embodiments. The customized preflight checklist GUI may include another screen for preflight checks associated with the left fuselage and left engine compartment.

FIG. 4J is a screenshot 445 of the customized preflight checklist GUI that includes preflight checks associated with the belly of the aircraft, in accordance with one or more embodiments.

FIG. 4K is a screenshot 450 of the customized preflight checklist GUI that includes preflight checks associated with the main rotor of the aircraft, in accordance with one or more embodiments.

FIG. 4L is a screenshot 455 of the customized preflight checklist GUI that includes preflight checks associated with the nose of the aircraft, in accordance with one or more embodiments.

FIG. 4M is a screenshot 460 of the customized preflight checklist GUI that includes preflight checks associated with the cabin area of the aircraft, in accordance with one or more embodiments.

As previously stated, FIGS. 4A-4M are examples screenshots of a customized preflight checklist GUI. In other embodiments, a customized preflight checklist GUI may include different information than described with respect to FIGS. 4A-4M.

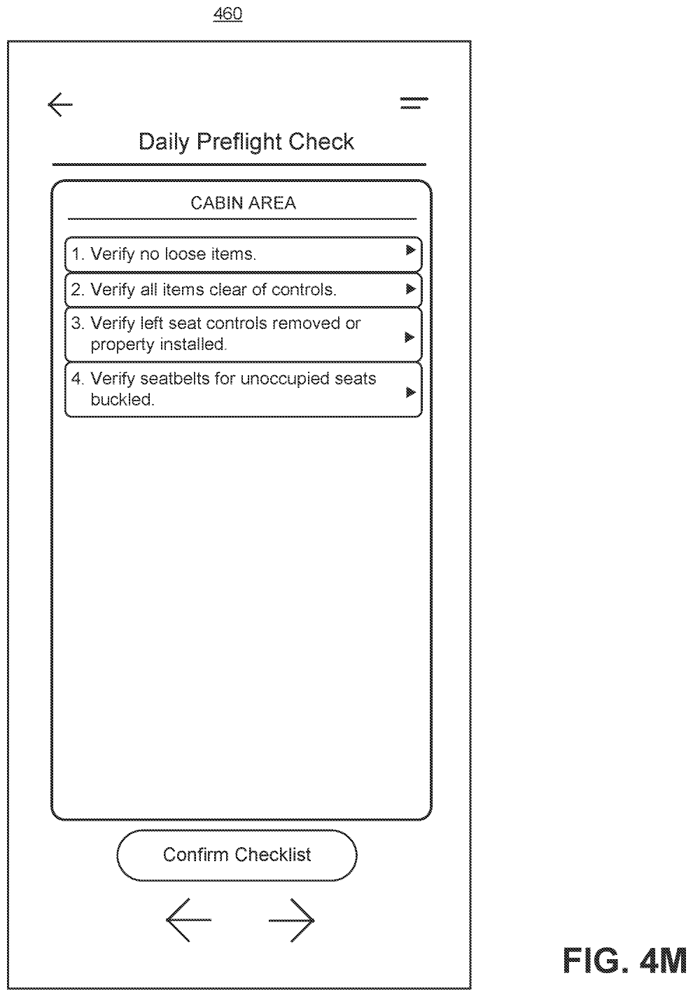

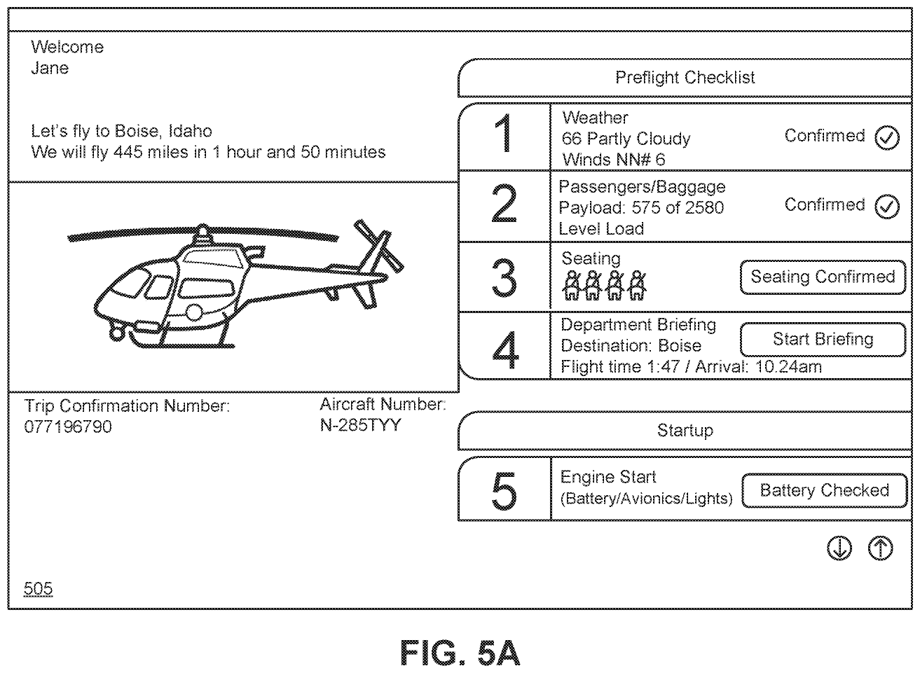

FIG. 5A is another example of a screenshot 505 of a portion of a customized checklist GUI, in accordance with one or more embodiments. The screenshot 505 includes a diagram of the aircraft (left side) and various details about an upcoming trip, such as the destination (“Boise, Idaho”), travel duration (“1 hour and 50 minutes”), travel distance (“445 miles”), trip confirmation number (“077196790”), and aircraft identification number (“N-285TYY”). The screenshot 505 includes five preflight checks (numbered 1-5). The screenshot 505 indicates checks 1-2 were completed (check marks on the right side) and checks 3-5 are yet to be completed. Since screenshot 505 is part of a customized checklist GUI, the preflight checks may be based on sensor data. For example, the payload weight may be based on weight sensors. In another example, the number of human diagrams illustrated in preflight check 3 may indicate how many passengers are in the aircraft (e.g., based on pressure sensors in the seats). By interacting with the GUI, the user can then confirm or modify how many passengers are actually in the aircraft.

FIG. 5B is another example of a screenshot 510 of a portion of a customized checklist GUI, in accordance with one or more embodiments. Screenshot 510 may be part of the checklist GUI in FIG. 5A or a different checklist GUI. Screenshot 510 includes eight preflight checks (numbered 1-8). Text on the right side describes each of the preflight checks. The screenshot 510 indicates checks 1-5 were completed (the buttons are highlighted) and checks 6-8 are yet to be completed (buttons are not highlighted). Since screenshot 510 is part of a customized checklist GUI, the preflight checks may be specific to the selected aircraft instead of generic preflight checks (e.g., specific to the type or identification number of the aircraft).

### Example Methods

FIGS. 6-9 are flowcharts describing various processes, according to some embodiments. Any features or steps in FIGS. 6-9 described as needed, essential, important, or otherwise implied to be required should be interpreted as only being required for that embodiment and not necessarily included in other embodiments.

FIG. 6 is a flowchart for remotely monitoring an aircraft (e.g., using a client device), in accordance with one or more embodiments. Remote monitoring allows a user to connect to an aircraft (via a client device) to check the state of the aircraft (e.g., check fuel quantity, GPS position, and other quantities). Remote monitoring may be useful if the user is distant from the aircraft but would like to check the state of the aircraft. The steps of FIG. 6 are illustrated from the perspective of an aircraft system performing the method. However, some or all of the steps may be performed by other entities or components. In addition, some embodiments may perform the steps in parallel, perform the steps in different orders, or perform different steps. One or more steps of the method may be stored as instructions in a non-transitory computer-readable storage medium.

At step 605, a communication channel is established between a client device (e.g., 350) of a user and an aircraft. The communication channel may be initiated by the client device (e.g., in response to the user indicating they want to monitor the aircraft).

At step 620, the aircraft receives a data request (through the communication channel) from the client device. The data request may request data from specific sensors or from all available sensors. For example, the aircraft recognizes the data request and begins checking quantities of the aircraft (see next steps) according to the request.

At steps 625, 630, and 635 the aircraft checks various quantities of the aircraft via sensors (e.g., vehicle sensors 140). Specifically, at step 625, the aircraft checks the fuel level (in other words, the fuel quantity), at step 630 the aircraft checks a battery energy level (e.g., the battery voltage), and at step 635 the aircraft checks the GPS position of the aircraft. In some embodiments, other quantities can be checked. For example, at step 640 the aircraft checks the OAT (outside air temperature), and at step 645 the aircraft checks a cabin camera. Note that steps 625, 630, 635, 640, and 645 are examples. Other quantities may be checked using other sensors.

In some embodiments, the sensors available to provide data depend on the power supply of the aircraft. Example power supplies include the aircraft main power (e.g., when the engines are on), ground power (e.g., shore power), and battery power. Depending on the available power supply, different sensors (and aircraft functionalities) may be available. For example, a cabin camera may be accessible if the aircraft is powered by the main power or the ground power but not the battery power. In another example, the fuel sensor or GPS sensor may be available with any power supply. Operating on the battery power may be considered operating on low power and a select number of components or sensors may be available in this circumstance. In some embodiments, a gateway computer and modem or antenna of the aircraft are functional with the battery power.

In some embodiments, if the aircraft is connected to ground power, full time remote monitoring is available. If the aircraft is not connected to ground power and is operating on battery power, a low-power subsystem wakes itself up periodically via a watchdog timer, checks for updates, and publishes any new data. If the battery energy level drops below a certain point, the remote monitoring system shuts itself down so as to not drain the battery further.

At step 650, the aircraft sends the checked quantities (e.g., based on the retrieved sensor data) to the client device.

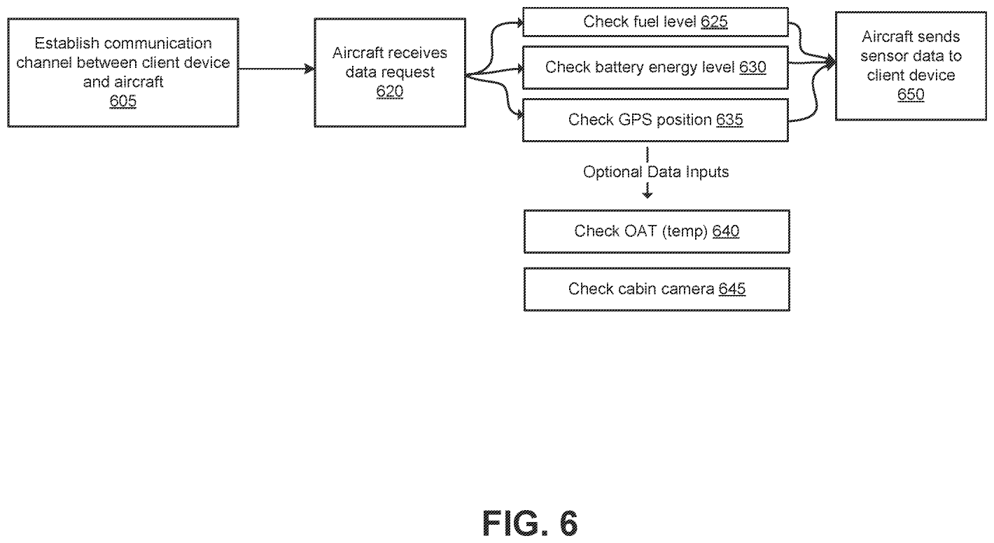

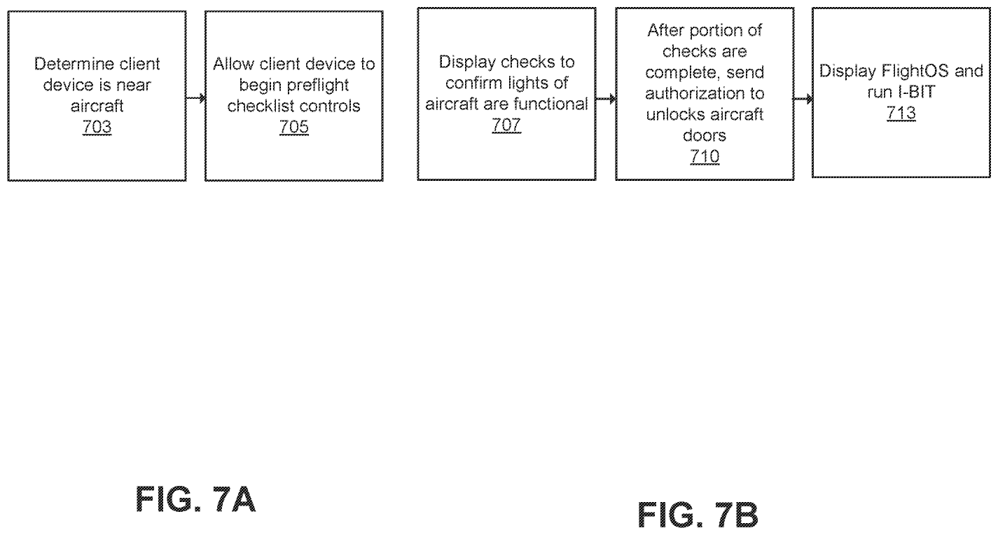

FIG. 7A is a flowchart for steps that may occur when a user with a client device (e.g., 350) approaches a selected aircraft (e.g., to perform a preflight check), according to an embodiment. The steps of FIG. 7A are illustrated from the perspective of an aircraft system performing the method. However, some or all of the steps may be performed by other entities or components. In addition, some embodiments may perform the steps in parallel, perform the steps in different orders, or perform different steps. One or more steps of the method may be stored as instructions in a non-transitory computer-readable storage medium.

At step 703, the aircraft determines the client device is near the aircraft (e.g., within a threshold distance). For example, a standby system of the aircraft determines the client device is near after receiving GPS data indicating the location of the client device. In another example, the aircraft and client device use BLUETOOTH® capabilities to determine the client device is nearby.

At step 705, the aircraft allows the client device to begin preflight checklist controls. For example, the aircraft transmits sensor data to the client device and accepts operational instructions from the client device.

Steps similar to 703 and 705 may be performed by the client device. For example, the client device (e.g., via the authorization module) may determine it is near the aircraft and allow checks of a preflight checklist GUI to be completed.

FIG. 7B is a flowchart for steps that may occur during a preflight check (e.g., after the flowchart in FIG. 7A is complete), in accordance with one or more embodiments. The steps of FIG. 7B are illustrated from the perspective of a client device (e.g., 350) performing the method. However, some or all of the steps may be performed by other entities or components. In addition, some embodiments may perform the steps in parallel, perform the steps in different orders, or perform different steps. One or more steps of the method may be stored as instructions in a non-transitory computer-readable storage medium. As previously stated, the client device may be physically separate from the aircraft (e.g., a personal smartphone) or physically coupled to the aircraft (e.g., part of the aircraft).

At step 707, the client device (e.g., via a preflight checklist GUI) displays a preflight check to confirm one or more lights of the aircraft are functional. This may be performed without turning on the flight control computers of the aircraft.

At step 710, after the user completes a portion of preflight checks (of a preflight checklist GUI), the client device sends an authorization (e.g., via authorization module 375) to the aircraft to unlock doors of the aircraft, thus allowing the user to access the interior of the aircraft (e.g., to perform additional preflight checks).

At step 713, the client device initiates a flight operating system and runs I-BIT (Initiated Built In Test).

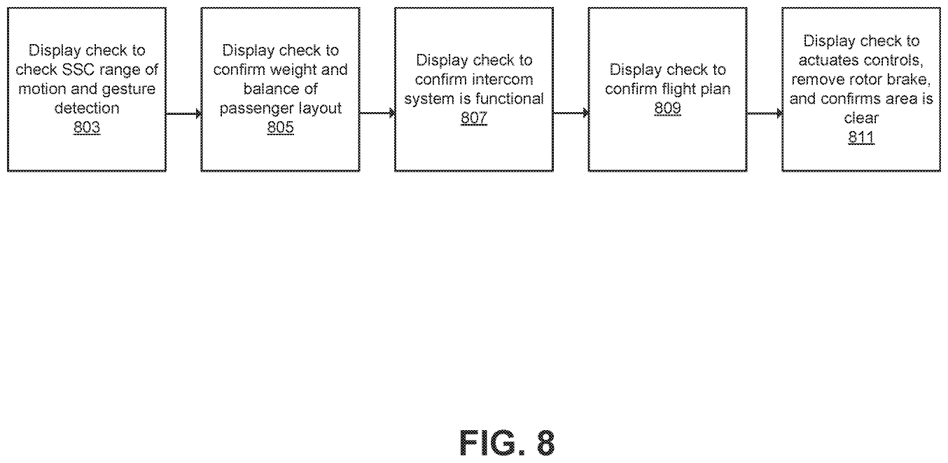

FIG. 8 is a flowchart for steps that may occur while a user is performing (e.g., manual) preflight checks of a preflight checklist GUI (e.g., after the flowchart in FIG. 7B is complete), in accordance with one or more embodiments. The steps of FIG. 8 are illustrated from the perspective of a client device (e.g., 350) performing the method. However, some or all of the steps may be performed by other entities or components. In addition, some embodiments may perform the steps in parallel, perform the steps in different orders, or perform different steps. One or more steps of the method may be stored as instructions in a non-transitory computer-readable storage medium. As previously stated, the client device may be physically separate from the aircraft (e.g., a personal smartphone) or physically coupled to the aircraft (e.g., part of the aircraft).

At step 803, the client device (e.g., via a preflight checklist GUI) displays a preflight check to check the SCC (side stick controller) range of motion and gesture detection. For example, the check is to determine whether there are any jams or blocks preventing movement of the SCC.

At step 805, the client device displays a preflight check to confirm the weight and balance of the passenger layout in the aircraft. For example, the check may be to confirm the current fuel amount is sufficient based on the weight and balance of the passenger layout.

At step 807, the client device displays a preflight check to confirm the aircraft intercom system is functional.

At step 809, the client device displays a preflight check to confirm a flight plan (e.g., displayed in the GUI).

At step 811, the client device displays a preflight check to actuate (e.g., mechanical) controls of the aircraft, remove the rotor brake of the aircraft, and confirm a surrounding area is clear.

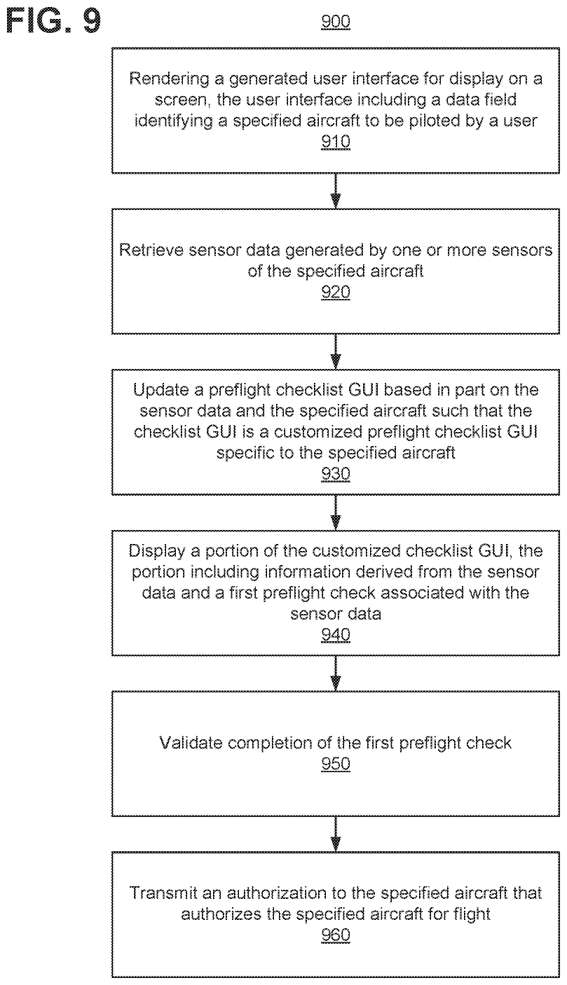

FIG. 9 is a flowchart describing an example computer implemented method 900 of generating and using a customized preflight checklist graphical user interface (GUI) specific to a specified aircraft, according to an embodiment. The steps of FIG. 9 are illustrated from the perspective of a client device (e.g., 350) performing the method 900. However, some or all of the steps may be performed by other entities or components (e.g., management module 330). In addition, some embodiments may perform the steps in parallel, perform the steps in different orders, or perform different steps. One or more steps of the method 900 may be stored as instructions in a non-transitory computer-readable storage medium.

The client device renders 910 a generated user interface for display on a screen, the user interface including a data field identifying a specified aircraft to be piloted by a user (an aircraft may be identified by its tail number). The aircraft may be specified by: (a) the user selecting the aircraft on the user interface or another user interface; (b) the client device scanning a bar code; (c) the client device scanning a QR, code; (d) the client device receiving a tail number of the aircraft (e.g., entered by the user); (e) the client device scanning a detail on the aircraft exterior; (f) or some combination thereof. In some embodiments, the client device receives a list of aircraft available to be piloted (e.g., for the user to pilot) and displays images of the available aircraft on the list. The user may select the aircraft after reviewing the images of the available aircraft.

The client device retrieves 920 sensor data generated by one or more sensors of the specified aircraft. For example, the client device sends a data request, and the aircraft (or a management module) aggregates sensor data based on the request and sends the aggregated data to the client device.

The client device updates 930 a preflight checklist GUI based in part on the sensor data and the specified aircraft such that the preflight checklist GUI is a customized preflight checklist GUI specific to the specified aircraft.

The client device displays 940 or provides for display at least a portion of the customized preflight checklist GUI. The customized preflight checklist GUI includes a plurality of preflight checks for completion. The portion of the customized preflight checklist GUI includes information derived from the sensor data and a first preflight check associated with the sensor data. In some embodiments, the customized preflight checklist GUI includes an image of the specified aircraft.

The client device validates 950 completion of the first preflight check. The client device may validate completion of the first preflight check subsequent to (e.g., responsive to) receiving an input (e.g., by the user) via the customized preflight checklist GUI that confirms completion of the first preflight check. In some embodiments, method 900 is performed without performing step 950.

The client device transmits 960 an authorization to the specified aircraft that authorizes the aircraft for flight (and, in some embodiments, authorizes the user to pilot the aircraft). In some embodiments, the user cannot access the aircraft or pilot the aircraft until the authorization is sent. The client device may transmit the authorization subsequent to (e.g., responsive to) determining that a set of the plurality of preflight checks are completed (e.g., and validated). The set may include each of the plurality preflight checks of the customized preflight checklist GUI or a (e.g., predetermined) subset of the plurality preflight checks. In some embodiments, the authorization is sent subsequent to determining the client device is within a threshold distance of the specified aircraft.

The sensor data may include a fuel level, oil level, or battery energy level of the specified aircraft, and the information of the customized preflight checklist GUI may include the fuel level, oil level, or battery energy level of the specified aircraft. The first preflight check may instruct the user to confirm the fuel level is above a threshold level or sufficient for a schedule flight plan.

In some embodiments, the client device retrieves a maintenance record of the specified aircraft. A second preflight check of the customized preflight checklist GUI may instruct the user to review the maintenance record and confirm the specified aircraft is capable of flying (e.g., see FIG. 4D and related description).

A second preflight check of the customized preflight checklist GUI may instruct the user to capture an image of a portion of the specified aircraft that includes damage or instruct the user to inspect an exterior portion of the specified aircraft. The instruction may be specific to the specified aircraft. For example, the instructions may state that the specified aircraft has minor damage to a rotor blade and may instruct the user to confirm the damage to the rotor blade hasn't increased.

The plurality of plurality of preflight checks of the customized preflight checklist GUI may include a set of preflight checks associated with an exterior of the specified aircraft and a set of preflight checks associated with an interior of the specified aircraft. Subsequent to determining the set of preflight checks associated with the exterior of the specified aircraft are completed (e.g., and validated), the client device may transmit a second authorization to the specified aircraft that authorizes the user to access the interior of the specified aircraft.

In some embodiments, the client device transmits an operational instruction to the aircraft to help the user complete a preflight check. For example, the client device transmits an instruction to turn on a light.

### Computing Machine Architecture

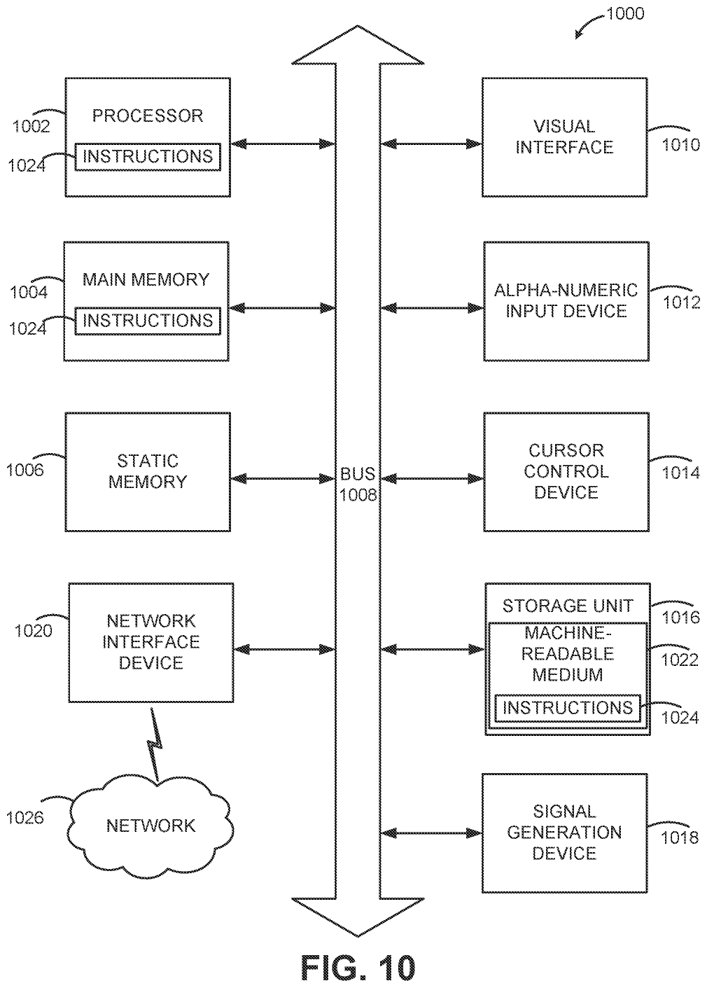

FIG. 10 is a block diagram illustrating one embodiment of components of an example machine able to read instructions from a machine-readable medium and execute them in a processor system. The processor system includes a set of one or more processors (or controllers). Specifically, FIG. 10 shows a diagrammatic representation of a machine in the example form of a computer system 1000 within which program code (e.g., software) for causing the machine to perform any one or more of the methodologies discussed herein may be executed, e.g., the rendering of the user interfaces in FIGS. 4A though 5B and the processes executed to render them. The client device (e.g., 350) may be a computing system 1000. Furthermore, the computer system 1000 may be used for one or more components of the vehicle control and interface system 100. The program code may be comprised of instructions 1024 executable by a set of one or more processors 1002 (if multiple processors, they may work individually or collectively to execute the instructions 1024). In alternative embodiments, the machine operates as a standalone device or may be connected (e.g., networked via network 1026) to other machines. In a networked deployment, the machine may operate in the capacity of a server machine or a client machine in a server-client network environment, or as a peer machine in a peer-to-peer (or distributed) network environment.

The machine may be a computing system capable of executing instructions 1024 (sequential or otherwise) that specify actions to be taken by that machine. Further, while only a single machine is illustrated, the term “machine” shall also be taken to include any collection of machines that individually or jointly execute instructions 1024 to perform any one or more of the methodologies discussed herein.

The example computer system 1000 includes a set of one or more processors 1002 (e.g., one or more central processing units (CPUs), one or more graphics processing units (GPUs), one or more digital signal processors (DSPs), one or more application specific integrated circuits (ASICs), one or more radio-frequency integrated circuits (RFICs), one or more field programmable gate arrays (FPGAs), or some combination thereof), a main memory 1004, and a static memory 1006, which are configured to communicate with each other via a bus 1008. The computer system 1000 may further include visual display interface 1010. The visual interface may include a software driver that enables (or provide) user interfaces to render on a screen either directly or indirectly. The visual interface 1010 may interface with a touch enabled screen. The computer system 1000 may also include input devices (such as an alpha-numeric input device 1012 (e.g., a keyboard) or a cursor control device 1014 (e.g., a mouse)), a storage unit 1016, a signal generation device 1018 (e.g., a microphone and/or speaker), and a network interface device 1020, which also are configured to communicate via the bus 1008.

The storage unit 1016 includes a machine-readable medium 1022 (e.g., magnetic disk or solid-state memory) on which is stored instructions 1024 (e.g., software) embodying any one or more of the methodologies or functions described herein. The instructions 1024 (e.g., software) may also reside, completely or at least partially, within the main memory 1004 or within the processor 1002 (e.g., within a processor's cache memory) during execution.

### Additional Configuration Considerations

Among other advantages, embodiments described herein enable a user to complete a preflight checklist faster and with more accuracy. Furthermore, the client device may validate completion of certain tasks on the preflight checklist and may authorize the user to pilot the aircraft after the preflight checklist is complete. By validating certain tasks and waiting to authorize the user, the client device may help ensure one or more necessary or important preflight checks are completed before the user begins piloting the aircraft. In some embodiments, checklist interaction may enable corrective action for the aircraft. For example, due to the checklist interaction, the GPS may be recalibrated. In another example, the flight plan of the aircraft may be modified to accommodate the current state of one or more components (determined during the checklist interaction). For example, in response to certain interactions with the preflight checklist, the one or more systems (e.g., the management module 330 or the client device 350) may determine a flight plan should be modified and provide a flight plan modification recommendation to the user performing the preflight check.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Use of “a” or “an” preceding an element, component, or module is done merely for convenience. This description should be understood to mean that one or more of the elements or components are present unless it is obvious that it is meant otherwise.

Certain embodiments are described herein as including logic or a number of components, modules, or mechanisms. Modules may constitute either software modules (e.g., code embodied on a machine-readable medium and processor executable), hardware modules, or any combinations thereof. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art.

As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for universal vehicle pre operation checks through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer implemented method comprising:
rendering a generated user interface for display on a screen of a computing device, the user interface including a data field identifying a specified aircraft to be piloted by a user;
retrieving sensor data generated by one or more sensors of the specified aircraft;
updating a preflight checklist graphical user interface (GUI) based in part on the sensor data and the specified aircraft such that the preflight checklist GUI is a customized preflight checklist GUI specific to the specified aircraft;
providing for display on the computing device at least a portion of the customized preflight checklist GUI, the customized preflight checklist GUI including a plurality of preflight checks for completion and the portion of the customized preflight checklist GUI includes information derived from the sensor data and a first preflight check associated with the sensor data;
subsequent to receiving an input via the customized preflight checklist GUI confirming completion of the first preflight check, validating completion of the first preflight check; and
subsequent to determining that a set of the plurality of preflight checks are completed and validated, transmitting an authorization to the specified aircraft that authorizes the specified aircraft for flight.

2. The method of claim 1, wherein the customized preflight checklist GUI includes an image of the specified aircraft.

3. The method of claim 1, wherein the sensor data includes a fuel level of the specified aircraft, and the information of the customized preflight checklist GUI includes the fuel level of the specified aircraft.

4. The method of claim 3, wherein the first preflight check instructs the user to confirm the fuel level is above a threshold level.

5. The method of claim 1, wherein the sensor data includes an oil level of the specified aircraft, and the information of the customized preflight checklist GUI includes the oil level of the specified aircraft.

6. The method of claim 1, further comprising retrieving a maintenance record of the specified aircraft, and wherein a second preflight check of the customized preflight checklist GUI instructs the user to review the maintenance record and confirm the specified aircraft is capable of flying.

7. The method of claim 1, wherein a second preflight check of the customized preflight checklist GUI instructs the user to capture an image of a portion of the specified aircraft that includes damage.

8. The method of claim 1, wherein a second preflight check of the customized preflight checklist GUI instructs the user to inspect an exterior portion of the specified aircraft.

9. The method of claim 1, wherein the customized preflight checklist GUI includes a preflight check associated with an exterior of the specified aircraft and a preflight check associated with an interior of the specified aircraft.

10. The method of claim 9, further comprising, subsequent to determining the preflight checks associated with the exterior of the specified aircraft are completed, transmitting a second authorization to the specified aircraft that authorizes the user to access the interior of the specified aircraft.

11. The method of claim 1, wherein the user cannot pilot the aircraft until the authorization is transmitted.

12. The method of claim 1, further comprising:
receiving a list of aircraft available to be piloted, wherein the specified aircraft is on the list; and
displaying images of the available aircraft on the list.

13. The method of claim 1, wherein the authorization is sent subsequent to determining the client device is within a threshold distance of the specified aircraft.

14. The method of claim 1, further comprising transmitting an operational instruction to the aircraft.

15. A non-transitory computer-readable storage medium comprising stored instructions, the instructions when executed by a client device, causing the client device to:
render a generated user interface for display on a screen of a computing device, the user interface including a data field identifying a specified aircraft to be piloted by a user;
retrieve sensor data generated by one or more sensors of the specified aircraft;
update a preflight checklist graphical user interface (GUI) based in part on the sensor data and the specified aircraft such that the preflight checklist GUI is a customized preflight checklist GUI specific to the specified aircraft;
providing for display at least a portion of the customized preflight checklist GUI, the customized preflight checklist GUI including a plurality of preflight checks for completion and the portion of the customized preflight checklist GUI includes information derived from the sensor data and a first preflight check associated with the sensor data;
subsequent to receiving an input via the customized preflight checklist GUI confirming completion of the first preflight check, validate completion of the first preflight check; and
subsequent to determining that a set of the plurality of preflight checks are completed and validated, transmit an authorization to the specified aircraft that authorizes the specified aircraft for flight.

16. The non-transitory computer-readable storage medium of claim 15, wherein the customized preflight checklist GUI includes an image of the specified aircraft.

17. The non-transitory computer-readable storage medium of claim 15, wherein the sensor data includes a fuel level of the specified aircraft, and the information of the customized preflight checklist GUI includes the fuel level of the specified aircraft.

18. The non-transitory computer-readable storage medium of claim 17, wherein the first preflight check instructs the user to confirm the fuel level is above a threshold level.

19. The non-transitory computer-readable storage medium of claim 15, wherein the sensor data includes an oil level of the specified aircraft, and the information of the customized preflight checklist GUI includes the oil level of the specified aircraft.

20. A system comprising:
a processor system; and
a computer-readable storage medium comprising stored instructions, the instructions when executed by the processor system, causing the set of one or more processors to:
render a generated user interface for display on a screen of a computing device, the user interface including a data field identifying a specified aircraft to be piloted by a user;
retrieve sensor data generated by one or more sensors of the specified aircraft;
update a preflight checklist graphical user interface (GUI) based in part on the sensor data and the specified aircraft such that the preflight checklist GUI is a customized preflight checklist GUI specific to the specified aircraft;
provide for display at least a portion of the customized preflight checklist GUI, the customized preflight checklist GUI including a plurality of preflight checks for completion and the portion of the customized preflight checklist GUI includes information derived from the sensor data and a first preflight check associated with the sensor data;
subsequent to receiving an input via the customized preflight checklist GUI confirming completion of the first preflight check, validate completion of the first preflight check; and
subsequent to determining that a set of the plurality of preflight checks are completed and validated, transmitting an authorization to the specified aircraft that authorizes the specified aircraft for flight.
